(19) United States
(12) Patent Application Publication
(10) Pub. No.: US 2025/0293233 A1
(43) Pub. Date: Sep. 18, 2025

(54) ELECTRODE AND METHOD FOR PRODUCING ELECTRODE

(71) Applicants: Kayato OHYA, Kanagawa (JP); Masako ICHINOSE, Kanagawa (JP); Toshiya SHIRAKURA, Kanagawa (JP); Aya UTSUKI, Tokyo (JP); Toshiya SAGISAKA, Kanagawa (JP); Masayoshi NOMURA, Shizuoka (JP); Kenji KOMITO, Tokyo (JP); Isamu NAKAGAWA, Kanagawa (JP)

(72) Inventors: Kayato OHYA, Kanagawa (JP); Masako ICHINOSE, Kanagawa (JP); Toshiya SHIRAKURA, Kanagawa (JP); Aya UTSUKI, Tokyo (JP); Toshiya SAGISAKA, Kanagawa (JP); Masayoshi NOMURA, Shizuoka (JP); Kenji KOMITO, Tokyo (JP); Isamu NAKAGAWA, Kanagawa (JP)

(21) Appl. No.: 19/077,068

(22) Filed: Mar. 12, 2025

(30) Foreign Application Priority Data
Mar. 15, 2024 (JP) 2024-040885

(51) Int. Cl. H01M 4/13; H01M 4/02; H01M 4/04; H01M 4/139; H01M 4/62

(52) U.S. Cl. CPC H01M 4/13; H01M 4/0404; H01M 4/043; H01M 4/139; H01M 4/621; H01M 2004/021

(57) ABSTRACT

An electrode is provided that includes a base and an electrode composite layer on the base. The electrode composite layer includes an active material and a binder. A concentration of the binder in the electrode composite layer varies periodically and continuously in at least one direction perpendicular to a thickness direction of the electrode composite layer.

### CROSS-REFERENCE TO RELATED APPLICATION

This patent application is based on and claims priority pursuant to 35 U.S.C. § 119 (a) to Japanese Patent Application No. 2024-040885, filed on Mar. 15, 2024, in the Japan Patent Office, the entire disclosure of which is hereby incorporated by reference herein.

### BACKGROUND

### Technical Field

The present disclosure relates to an electrode and a method for producing an electrode.

### Related Art

In recent years, the range of applications of electrochemical elements such as lithium-ion batteries, electric double-layer capacitors, lithium-ion capacitors, and redox capacitors has been rapidly expanding, and such applications include small consumer devices such as wearable devices and smartphones, and large devices such as electric vehicles and stationary storage batteries.

Due to the diversifying needs of electrochemical elements, there is a need for a new method for producing electrodes that allows for flexible switching between different types of products.

### SUMMARY

Embodiments of the present disclosure provides an electrode that includes a base and an electrode composite layer on the base. The electrode composite layer includes an active material and a binder. A concentration of the binder in the electrode composite layer varies periodically and continuously in at least one direction perpendicular to a thickness direction of the electrode composite layer.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a schematic cross-sectional view of an electrode according to an embodiment of the present disclosure;

FIGS. 1B-A and 1B-B are schematic cross-sectional views for explaining a binder concentration gradient in an electrode according to an embodiment of the present disclosure;

FIG. 2 is a schematic cross-sectional view of an electrode according to an embodiment of the present disclosure;

FIG. 3 is a schematic cross-sectional view of an electrode according to an embodiment of the present disclosure;

FIG. 4 is an example of a binarized image in a method for measuring the average porosity of an electrode composite layer;

FIG. 5 is a schematic cross-sectional view of an electrode according to an embodiment of the present disclosure;

FIG. 6A is a schematic cross-sectional view of an electrode according to an embodiment of the present disclosure;

FIG. 6B is a schematic cross-sectional view of an electrode according to an embodiment of the present disclosure;

FIG. 7 is a schematic diagram of an apparatus for producing an electrode according to an embodiment of the present disclosure;

FIG. 8 is a schematic diagram of an apparatus for producing an electrode according to another embodiment of the present disclosure;

FIG. 9 is a schematic diagram of an apparatus for producing an electrode according to another embodiment of the present disclosure;

FIG. 10 is a schematic diagram of a variation of an apparatus for producing an electrode according to an embodiment of the present disclosure;

FIG. 11 is a configuration diagram of an example printing unit (first configuration), which employes an inkjet method and a transfer method, as an electrode composite layer-forming liquid composition applying unit in an apparatus for producing an electrode according to an embodiment of the present disclosure;

FIG. 12 is a configuration diagram of an example printing unit (second configuration), which employes an inkjet method and a transfer method, as an electrode composite layer-forming liquid composition applying unit in an apparatus for producing an electrode according to an embodiment of the present disclosure;

FIG. 13 is a schematic diagram of an example formation pattern of an electrode composite layer in a method for producing an electrode according to an embodiment of the present disclosure;

FIG. 14 is a schematic diagram of an example formation pattern of an electrode composite layer in a method for producing an electrode according to an embodiment of the present disclosure;

FIG. 15 is a schematic diagram of an example formation pattern of an electrode composite layer in a method for producing an electrode according to an embodiment of the present disclosure;

FIGS. 16A and 16B are schematic diagrams of an example formation pattern of an electrode composite layer in a method for producing an electrode according to an embodiment of the present disclosure;

FIG. 17 is a schematic cross-sectional view of an electrochemical element according to an embodiment of the present disclosure;

FIG. 18 is a schematic cross-sectional view of an electrochemical element according to an embodiment of the present disclosure; and

FIG. 19 is a schematic diagram of a moving body that is an electrochemical element according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present invention, an electrode having excellent cycle characteristics and rate characteristics is provided.

An electrode according to an embodiment of the present disclosure includes a base and an electrode composite layer on the base. In the electrode, the electrode composite layer includes an active material and a binder, and a concentration of the binder in the electrode composite layer varies periodically and continuously in at least one direction perpendicular to a thickness direction of the electrode composite layer.

Such an electrode has excellent cycle characteristics and rate characteristics.

Embodiments of the present invention will be described in detail below.

### (Electrode)

An electrode according to an embodiment of the present disclosure includes a base and an electrode composite layer, and may include another member as necessary.

Here, an embodiment of the present disclosure will be described with reference to the drawings. However, the present disclosure is not limited to these embodiments in any way.

In each drawing, the same reference numerals are given to the same components, and redundant explanation may be omitted. Further, the numbers, positions, shapes, and the like of constituent members are not limited to the present embodiment, and may include any numbers, positions, shapes, and the like that are preferable for implementing the present disclosure.

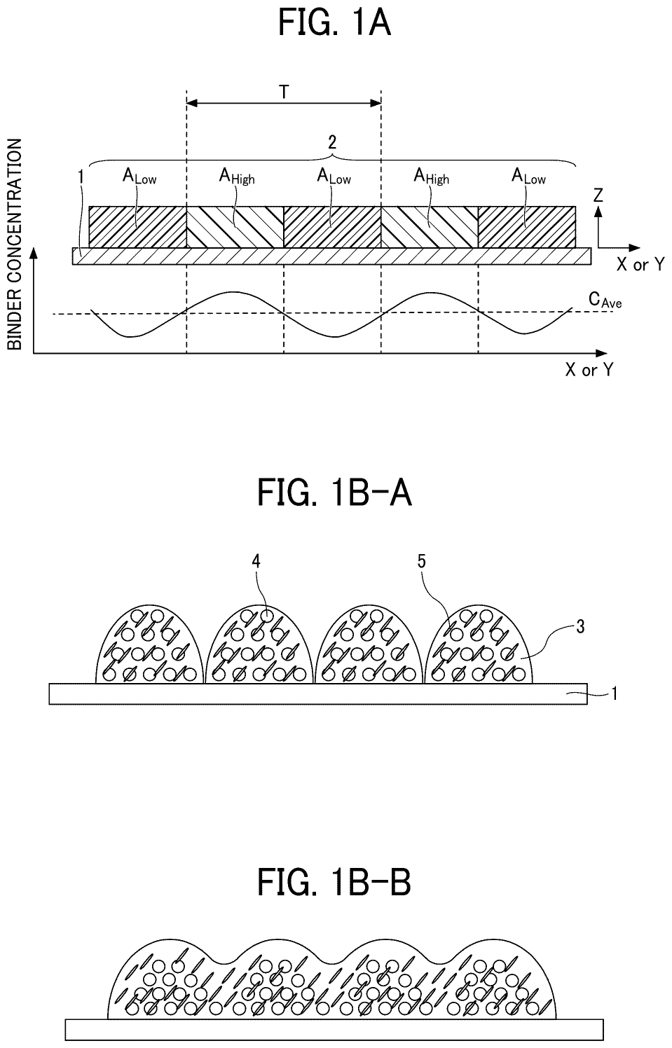

FIG. 1A is a schematic cross-sectional view of an electrode according to an embodiment of the present disclosure.

As illustrated in FIG. 1A, the electrode includes a base 1 and an electrode composite layer 2 provided on the base 1.

### <Base>

The base in the present disclosure is not particularly limited as long as the base is electronically conductive and is stable to the applied potential, and can be appropriately selected according to a purpose. Examples of the base include, but are not limited to, aluminum foil, copper foil, stainless steel foil, titanium foil, etched foils obtained by etching such foils to form fine holes, carbon-coated foils whose surface layer is coated with a carbon-containing resin layer, foils coated with a Phase-Transfer Catalyst (PTC) layer, and perforated bases used in lithium-ion capacitors.

In this specification, a base used in a negative electrode may be referred to as a “negative electrode base” or a “base for a negative electrode”, and a base used in a positive electrode may be referred to as a “positive electrode base” or a “base for a positive electrode”.

### <Electrode Composite Layer>

The electrode composite layer in the present disclosure includes an active material and a binder, and may include a conductive auxiliary agent and another component as necessary.

### <<Active Material>>

As the active material, a positive electrode active material and a negative electrode active material can be used. One type of positive electrode active material or negative electrode active material may be used alone, or two or more types thereof may be used in combination.

### —Positive Electrode Active Material—

The positive electrode active material is not particularly limited and can be appropriately selected according to a purpose, as long as the positive electrode active material is a material that can reversibly intercalate and release alkali metal ions. Examples of the positive electrode active material include, but are not limited to, a transition metal compound containing an alkali metal.

Examples of the transition metal compound containing an alkali metal include, but are not limited to, transition metal compounds containing lithium, such as composite oxides containing lithium and one or more elements selected from the group consisting of cobalt, manganese, nickel, chromium, iron, and vanadium.

Examples of the transition metal compounds containing lithium include, but are not limited to, lithium cobaltate, lithium nickelate, and lithium manganate.

Polyanionic compounds having an XO₄ tetrahedron (X=P, S, As, Mo, W, Si, and the like) in the crystal structure can be used as the transition metal compound containing an alkali metal. Among these, transition metal phosphate compounds containing lithium such as lithium phosphate and lithium vanadium phosphate are preferred from the viewpoint of cycle characteristics, and lithium vanadium phosphate is preferred from the viewpoint of the lithium diffusion coefficient and output characteristics.

When a polyanionic compound is used, a composite material including the polyanionic compound and coating of a conductive auxiliary agent such as a carbon material covering the surface of the polyanionic compound is preferably used to improve electron conductivity.

It is preferable that at least a portion of the surface of the transition metal compound containing an alkali metal is covered with an ion-conductive oxide. The ion-conductive oxide is preferably a lithium ion-conductive oxide.

The lithium ion-conductive oxide is not particularly limited and can be appropriately selected according to a purpose. Examples of the lithium ion-conductive oxide include, but are not limited to, oxides represented by the general formula LiₓAO_{y}, where A is B, C, Al, Si, P, S, Ti, Zr, Nb, Mo, Ta, Sc, V, Y, Ca, Sr, Ba, Hf, Ta, Cr, or W, and x and y are positive numbers.

Specific examples of lithium ion-conductive oxides include, but are not limited to, Li₃BO₃, LiBO₂, Li₂CO₃, LiAlO₂, Li₄SiO₄, Li₂SiO₃, Li₃PO₄, Li₂SO₄, Li₂TiO₃, Li₄TisO₁₂, Liz Ti₂O₅, Li₂ZrO₃, LiNbO₃, LiTaO₃, LizMoO₄, and Li₂WO₄. Among these, Li₄TisO₁₂, LizZrO₃, or LiNbO₃ is preferred.

The lithium ion-conductive oxide may be a composite oxide. As the composite oxide, any combination of lithium ion-conductive oxides can be used, and examples thereof include, but are not limited to, Li₄SiO₄—Li₃BO₃ and Li₄SiO₄—Li₃PO₄.

### —Negative Electrode Active Material—

The negative electrode active material is not particularly limited and can be appropriately selected according to a purpose, as long as the negative electrode active material is a material that can reversibly intercalate and release alkali metal ions. Examples of the negative electrode active material include, but are not limited to, carbon materials including graphite having a graphite-type crystal structure.

Examples of the carbon materials include, but are not limited to, natural graphite, spherical or fibrous artificial graphite, non-graphitizable carbon (hard carbon), and easily-graphitizable carbon (soft carbon).

Examples of negative electrode active materials other than carbon materials include, but are not limited to, lithium titanate and titanium oxide.

For increasing energy density of lithium-ion batteries, high capacity materials such as silicon, tin, silicon alloys, tin alloys, silicon oxide, silicon nitride, and tin oxide can also be preferably used as the negative electrode active material.

The mode diameter of the active material is not particularly limited and can be appropriately selected according to a purpose, but is preferably 0.5 μm or more and 20 μm or less, and more preferably 3 μm or more and 10 μm or less.

When the mode diameter of the active material is 0.5 μm or more and 20 μm or less, an electrode having better battery characteristics is easily obtained. Furthermore, when the mode diameter of the active material is 3 μm or more and 10 μm or less, an electrode having particularly good battery characteristics is obtained.

In this specification, the mode diameter is calculated as a diameter that gives the maximum value in the particle size distribution of the active material of the electrode composite layer-forming liquid composition.

A method of measuring the mode diameter of the active material is not particularly limited and can be appropriately selected according to a purpose. For example, the mode diameter of the active material may be measured in accordance with ISO 13320:2009.

A device used for measuring the mode diameter of the active material is not particularly limited and can be appropriately selected according to a purpose. Examples of the device include, but are not limited to, a laser-diffraction-based particle size analyzer (MASTERSIZER 3000, manufactured by MALVERN PANALYTICAL LTD).

The maximum particle size Dmax of the active material is not particularly limited and can be appropriately selected according to a purpose, but is preferably 40 μm or less, more preferably 30 μm or less, and even more preferably 20 μm or less.

When the maximum particle diameter Dmax of the active material is 40 μm or less, formation of protrusions due to unintended coarse active material is prevented in the obtained electrode composite layer, and thus the risk of short circuiting when covered with an insulating layer such as a separator can be reduced. Furthermore, if a pressing process is performed, damage to the active material caused by localized stress being applied to the protrusions is prevented.

A method of measuring the maximum particle size Dmax of the active material is not particularly limited and can be appropriately selected according to a purpose. For example, Dmax of the active material may be measured in accordance with ISO 13320:2009.

A device used for measuring Dmax of the active material is not particularly limited and can be appropriately selected according to a purpose. Examples of the device include, but are not limited to, a laser-diffraction-based particle size analyzer (MASTERSIZER 3000, manufactured by MALVERN PANALYTICAL LTD).

The median diameter D50 of the active material is not particularly limited and can be appropriately selected according to a purpose, but is preferably 0.5 μm or more and 20 μm or less, and more preferably 3 μm or more and 10 μm or less.

When the median diameter D50 of the active material is 0.5 μm or more and 20 μm or less, an electrode having better battery characteristics is easily obtained. Furthermore, when the median diameter D50 of the active material is 3 μm or more and 10 μm or less, an electrode having particularly good battery characteristics is obtained.

A method of measuring the median diameter D50 of the active material is not particularly limited and can be appropriately selected according to a purpose. For example, D50 of the active material may be measured in accordance with ISO 13320:2009.

A device used for measuring D50 of the active material is not particularly limited and can be appropriately selected according to a purpose. Examples of the device include, but are not limited to, a laser-diffraction-based particle size analyzer (MASTERSIZER 3000, manufactured by MALVERN PANALYTICAL LTD).

### <<Binder>>

There are no particular limitations on the binder, and the binder can be appropriately selected according to a purpose as long as the binder can achieve binding of the negative electrode material, binding of the positive electrode material, binding between the negative electrode material and the base for the negative electrode, or binding between the positive electrode material and a base for the positive electrode. When the electrode composite layer-forming liquid composition is applied by using inkjet discharge, a binder that does not substantially increase the viscosity of the electrode composite layer-forming liquid composition is preferably used for preventing nozzle clogging in a liquid discharge head.

As the binder, a polymer compound can be used.

Examples of the polymer compound include, but are not limited to, thermoplastic resins such as polyvinylidene fluoride (PVDF), acrylic resins, polyethylene, polypropylene, polyurethane, nylon, polytetrafluoroethylene, polyphenylene sulfide, polyethylene terephthalate, and polybutylene terephthalate; polyamide compounds, polyimide compounds, polyamide-imides, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), polyethyl methacrylate (PEMA), polybutyl methacrylate (PBMA), polyethylene vinyl acetate (PEVA), poly(2-(dimethylamino)ethyl methacrylate), poly(2-(diethylamino)ethyl methacrylate), poly(2-(dimethylamino)ethyl methacrylate-polybutyl methacrylate) copolymer, poly(2-(diethylamino)ethyl methacrylate-polybutyl methacrylate) copolymer, and carboxymethyl cellulose.

The content of the binder relative to the active material is not particularly limited and can be selected appropriately according to a purpose, but is preferably 0.5 mass % or more and 15 mass % or less, more preferably 1 mass % or more and 10 mass % or less, and even more preferably 1.5 mass % or more and 5 mass % or less.

When the content of the binder relative to the active material is 0.5 mass % or more, the active material can be firmly bound to the base, which is preferable.

### <<Conductive Auxiliary Agent>>

The conductive auxiliary agent is not particularly limited and can be appropriately selected according to a purpose. Examples of the conductive auxiliary agent include, but are not limited to, carbon black produced by a furnace method, an acetylene method, or a gasification method, and carbon materials such as carbon nanofibers, carbon nanotubes, graphene, and graphite particles.

Examples of the conductive auxiliary agent other than carbon materials include, but are not limited to, particles and fibers of metals such as aluminum. The conductive auxiliary agent and the active material may be combined in advance to form a composite material.

The content of the conductive auxiliary agent relative to the active material is not particularly limited and can be appropriately set according to a purpose, but is preferably 10 mass % or less, and more preferably 8 mass % or less.

The upper limit of the mass ratio of the conductive auxiliary agent to the active material is preferably 10 mass % or less, more preferably 5 mass % or less, and further preferably 3 mass % or less. When the mass ratio of the conductive auxiliary agent to the active material is equal to or less than the upper limit, the electrical conductivity of the resulting electrode composite layer is not impaired and the energy density can be further improved.

The lower limit of the mass ratio of the conductive auxiliary agent to the active material is preferably 1 mass % or more. When the mass ratio of the conductive auxiliary agent to the active material is equal to or more than the lower limit, the conductivity of the resulting electrode composite layer is further improved.

### <<Another Component>>

Another component is not particularly limited and can be appropriately selected according to a purpose. Examples of the other component include, but are not limited to, dispersants, solid electrolytes, surfactants, pH adjusters, rust inhibitors, preservatives, fungicides, antioxidants, anti-reduction agents, evaporation accelerators, chelating agents, and thickeners.

### <<<Dispersant>>>

The dispersant is not particularly limited and can be appropriately selected according to a purpose, as long as the dispersant can improve the dispersibility of the active material in the electrode composite layer-forming liquid composition. Examples of the dispersant include, but are not limited to, carboxymethyl cellulose, polymer-type dispersants based on polyethylene, polyethylene oxide, polypropylene oxide, polycarboxylic acid, naphthalene sulfonic acid formalin condensates, polyethylene glycol, partial alkyl esters of polycarboxylic acid, polyethers, and polyalkylene polyamine; low molecular weight dispersants based on alkyl sulfonic acid, quaternary ammonium, higher alcohol alkylene oxides, polyhydric alcohol esters, and alkyl polyamines; and inorganic-type dispersants such as polyphosphate dispersants. Among these, a dispersant having an ionic adsorptive group is preferred from the viewpoint of dispersibility.

### <<<Solid Electrolyte>>>

The solid electrolyte is not particularly limited and may be appropriately selected according to a purpose as long as the solid electrolyte is electronically insulative and ion-conductive and does not react with the dispersion medium. Examples of the solid electrolyte include, but are not limited to, oxide solid electrolytes and sulfide solid electrolytes. Among these, sulfide solid electrolytes are preferred because sulfide solid electrolytes are highly plastic and thus can form good interfaces between solid electrolyte particles or between the solid electrolyte and the active material, and crystalline argyrodite-type sulfide solid electrolytes are more preferred because crystalline argyrodite-type sulfide solid electrolytes exhibit excellent dispersibility comparable to that of the active material.

Examples of oxide solid electrolytes include, but are not limited to, compounds that contain oxygen atoms, can conduct ions of a metal belonging to group 1 or 2 of the periodic table, and provide electronic insulation.

As used herein, the phrase “provide electronic insulation” refers to a state in which a short circuit does not occur when a positive electrode and a negative electrode are placed opposite each other with a solid electrolyte layer interposed therebetween.

As used herein, the phrase “exhibit ion conductivity” means that when a positive electrode and a negative electrode are placed opposite each other with a solid electrolyte layer interposed therebetween, application of a potential difference only causes movement of ions.

Specific examples of oxide solid electrolytes include, but are not limited to, LiₓₐLa_{ya}TiO₃ [where xa=from 0.3 to 0.7, ya=from 0.3 to 0.7] (LLT), Li_{xb}La_{yb}Zr_{zb}Mbb_{mb}O_{nb} (where Mbb is at least one element selected from the group consisting of Al, Mg, Ca, Sr, V, Nb, Ta, Ti, Ge, In, and Sn, 5≤xb≤10, 1≤yb≤4, 1≤zb≤4, 0≤mb≤2, and 5≤nb≤20), Li_{xc}B_{yc}Mcc_{zc}Oₙₑ (where Mcc is at least one element selected from the group consisting of C, S, Al, Si, Ga, Ge, In, and Sn, 0≤xc≤5, 0≤yc≤1, 0≤zc≤1, and 0≤nc≤6), Li_{xd}(Al, Ga)_{yd}(Ti, Ge)_{zd}Si_{ad}P_{md}O_{nd} (where 1≤xd≤3, 0≤yd≤1, 0≤zd≤2, 0≤ad≤1, 1≤md≤7, 3≤nd≤13), Li (3−2xe) MeeₓₑDeeO (where xe is 0 or more and 0.1 or less, and Mee is a divalent metal atom, and Dee represents a halogen atom or a combination of two or more different halogen atoms), Li_{xf}Si_{yf}O_{zf} (where 1≤xf≤5, 0<yf≤3, 1≤zf≤10), Li_{xg}S_{yg}O_{zg} (where 1≤xg≤3, 0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)} Nw (where w<1), Li_{3.5}Zn_{0.25}GeO₄ having a Lithium super ionic conductor (LISICON) type crystal structure, La_{0.55}Li_{0.35}TiO₃ having a perovskite type crystal structure, LiTi₂P₃O₁₂ having a sodium (Na) super ionic conductor (NASICON) type crystal structure, Li_{1+xh+yh} (Al, Ga)xh(Ti, Ge)₂₋ₓₕSi_{yh}P_{3-yh}O₁₂ (where 0≤xh≤1, 0≤yh≤1), and Li₇La₃Zr₂O₁₂ (LLZ) having a garnet type crystal structure.

As the oxide solid electrolyte, a phosphorus compound containing Li, P and O is also preferable. Examples of the phosphorus compound include, but are not limited to, lithium phosphate (Li₃PO₄), LiPON obtained by replacing some of oxygen in lithium phosphate with nitrogen, and LiPOD1 (where D1 is at least one selected from the group consisting of Ti, V, Cr, Mn, Fe, Co, Ni, Cu, Zr, Nb, Mo, Ru, Ag, Ta, W, Pt, Au, etc.).

LiAlON (Al is at least one selected from the group consisting of Si, B, Ge, Al, C, Ga, etc.) can also be preferably used.

Sulfide solid electrolytes can be roughly categorized into, for example, crystalline sulfide solid electrolytes and sulfide glass solid electrolytes.

Examples of crystalline sulfide solid electrolytes include, but are not limited to, Li_{9.54}Si_{1.74}P_{1.44}S_{11.7}Cl_{0.3}, Li_{9.6}P₃S₁₂, LigP₃S₉O₃, Li_{9.81}Sn_{0.81}P_{2.19}S₁₂, Li_{9.42}Si_{1.02}P_{2.1}S_{9.96}O_{2.04}, Li₁₀Ge(P₁₋ₓSbₓ)₂S₁₂ (where 0≤x≤0.15), Li₁₀SnP₂S₁₂, Li_{10.35} [M1₁₋ₓM2ₓ]_{1.35}P_{1.65}S₁₂ (where M1, M2=Si, Ge, Sn, As, or Sb, 0≤x≤0.15), LinSi₂PS₁₂, LinAlP₂S₁₂, Li_{3.45}Si_{0.45}P_{0.55}S₄, Li₆PS₅X (where X=Cl, Br, I), LisPS₄X₂ (where X=Cl, Br, I), Li_{5.5}PS_{4.5}Cl_{1.5}, Li_{5.35}Ca_{0.1}PS_{4.5}Cl_{1.55}, Li₆₊ₓMₓSb₁₋ₓSsI (where M=Si, Ge, Sn, 0≤x≤1), Li₇P₂S₈I, γ-Li₃PS₄, Li₄MS4 (where M=Ge, Sn, As), Li₄₋ₓSn₁₋ₓSbxS₄ (where 0≤x≤0.15), Li₄₋ₓGe₁₋ₓPxS₄ (where 0≤x≤0.15), and Li₃₊₅ₓP₁₋ₓS₄ (where 0≤x≤0.3).

Examples of sulfide glass solid electrolytes include, but are not limited to, Li₂S—P₂S₅, Li₂S—P₂S₅—LiI, Li₂S—P₂S₅—P₂O₅, Li₂S—P₂S₅—LiCl, Li₂S—SiS₂, Li₂S—SiS₂—P₂S₅, Li₂S—SiS₂—Al₂S₃, and Li₂S—SiS₂-LiₓMO_{y} (where M=Si, P, Ge).

Also usable are Li₂P₃S₁₁ glass ceramics in which a part of a sulfide glass solid electrolyte is crystallized. Here, the mixing ratio of each of the raw materials for the sulfide glass solid electrolyte is not limited.

In embodiments of the present invention, as illustrated in FIG. 1A, the binder concentration in the electrode composite layer 2 varies periodically and continuously in at least one direction perpendicular to a thickness direction of the electrode composite layer 2. More specifically, it is preferable that regions A_{High} with a binder concentration higher than the average binder concentration C_{AVE} in the electrode composite layer 2 and regions A_{Low} with a binder concentration lower than the average binder concentration C_{AVE} in the electrode composite layer 2 are present periodically and continuously.

As used herein, “regions A_{High} with the higher binder concentration and regions A_{Low} with the lower binder concentration are present periodically” means that, in at least one direction perpendicular to the thickness direction of the electrode composite layer 2, the regions A_{High} with a binder concentration higher than the average binder concentration C_{AVE} in the electrode composite layer 2 and the regions A_{Low} with a binder concentration lower than the average binder concentration C_{AVE} in the electrode composite layer 2 are present alternately and repeatedly. It is preferable that in the electrode composite layer, the regions A_{High} and the regions A_{Low} are present at a constant pitch.

Here, the constant pitch is preferably a pitch such that the region A_{High}: the region A_{Low} is in a range from 1:4 to 4:1, and more preferably the region A_{High}: the region A_{Low} is approximately 1:1. Therefore, the electrode composite layer 2 should be distinguished from a film having binder concentration variation that may occur when attempting to form a film with a uniform binder concentration.

As used herein, the phrase “regions A_{High} with the higher binder concentration and regions A_{Low} with the lower binder concentration are present continuously” means that, in at least one direction perpendicular to the thickness direction of the electrode composite layer 2, the binder concentration in the electrode composite layer gradually changes from the region A_{High} to the region A_{Low}, or vice versa. The electrode composite layer 2 should be distinguished from a layer in which there is significant difference in binder concentration (discontinuity), for example in the case where two active material layers with different binder concentrations are adjacent to each other. That is, the phrase indicates that there is no boundary, i.e., no interface, formed by significantly different binder concentrations.

The method for determining whether the binder concentration in the electrode composite layer is continuous is not particularly limited and can be appropriately selected according to a purpose. Here is an example of such a method.

### —Method A: Case of Binder Containing Characteristic Element—

Type 53 epoxy resin for embedding (Lot No. 53512040149, SANKEI CO., LTD.) as a base material and a curing agent (Lot No. 53572040342, SANKEI CO., LTD.) are thoroughly mixed (volume ratio: 1:2), and an electrode composite layer is embedded in the resin using a vacuum impregnation device (BUEHLER VACUUM IMPREGNATION EQUIPMENT I, SANKEI CO., LTD.) and allowed to harden for 24 hours. The electrode composite layer embedded in the epoxy resin is processed with CROSS SECTION POLISHER (manufactured by JEOL LTD.), a cross section of the electrode composite layer is observed with a desktop scanning electron microscope SEM/EDX (PHENOM PROX, manufactured by JASCO INTERNATIONAL CO., LTD.), and element mapping on the cross section is conducted.

If the binder does not contain any characteristic element, but the binder can be stained by using electron staining with osmium tetroxide or ruthenium tetroxide, element mapping is conducted by using this method.

### —Method B: Case of Binder Not Containing Characteristic Element—

The electrode composite layer is cut using a surface and interfacial cutting analysis system (SAICAS) at intervals that are 1/10 of the period intended for the production method, and the collected samples are subjected to pyrolysis GC/MS analysis to obtain peak values for fragments from the binder. These peak values are applied to a calibration curve obtained using known binder concentrations to quantify the binder concentration.

The period T of the binder concentration in the electrode composite layer 2 is not particularly limited and can be appropriately selected according to a purpose. However, for preventing detachment of the active material from the electrode composite layer and growth of Li dendrites and achieving excellent cycle characteristics, the period Tis preferably 0.2 mm or more and 2.5 mm or less. In addition, for achieving efficiently binding the active material, the period T is preferably 0.4 mm or more, more preferably 0.6 mm or more, and is preferably 1.7 mm or less, more preferably 1.3 mm or less.

When the period T of the binder concentration in the electrode composite layer 2 is 0.2 mm or more, it is possible to eliminate the problem of insufficient binding quality at the same or a similar level compared to an electrode having a uniform binder concentration, which results in poor cycle characteristics or insufficiency of another advantageous effect.

When the period T of the binder concentration in the electrode composite layer 2 is 2.5 mm or less, it is possible to eliminate the problem of insufficient binding of the active material in a region with a low binder concentration.

The period T of the binder concentration in the electrode composite layer 2 may be defined as a distance between adjacent maximums or adjacent minimums in the binder concentration distribution in the X direction or Y direction.

The method for measuring the period T of the binder concentration in the electrode composite layer is not particularly limited and can be appropriately selected according to a purpose. Here is an example of such a method.

### —Method A: Case of Binder Containing Characteristic Element—

Type 53 epoxy resin for embedding (Lot No. 53512040149, SANKEI CO., LTD.) as a base material and a curing agent (Lot No. 53572040342, SANKEI CO., LTD.) are thoroughly mixed (volume ratio: 1:2), and an electrode composite layer is embedded in the resin using a vacuum impregnation device (BUEHLER VACUUM IMPREGNATION EQUIPMENT I, SANKEI CO., LTD.) and allowed to harden for 24 hours. The electrode composite layer embedded in the epoxy resin is processed with CROSS SECTION POLISHER (manufactured by JEOL LTD.), a cross section of the electrode composite layer is observed with a desktop scanning electron microscope SEM/EDX (PHENOM PROX, manufactured by JASCO INTERNATIONAL CO., LTD.), and element mapping on the cross section is conducted. The period is calculated based on the binder concentration distribution in the X direction or the Y direction.

If the binder does not contain any characteristic element, but the binder can be stained by using electron staining with osmium tetroxide or ruthenium tetroxide, element mapping is conducted by using this method.

### —Method B: Case of Binder Not Containing Characteristic Element—

The electrode composite layer is cut using a surface and interfacial cutting analysis system (SAICAS) at intervals that are 1/10 of the period intended for the production method, and the collected samples are subjected to pyrolysis GC/MS analysis to obtain peak values for fragments from the binder. These peak values are applied to a calibration curve obtained using known binder concentrations to quantify the binder concentration. The period is calculated by plotting the binder concentration in each sample.

A mechanism by which the binder concentration changes continuously and periodically in the electrode of the present disclosure will be described with reference to FIGS. 1B-A and 1B-B.

FIGS. 1B-A and 1B-B are schematic cross-sectional diagrams for explaining a binder concentration gradient in an electrode according to an embodiment of the present disclosure.

FIG. 1B-A is a schematic cross-sectional diagram illustrating a state immediately after the electrode composite layer-forming liquid composition has been applied to the base 1. FIG. 1B-B is a schematic cross-sectional diagram of a state where droplets of the applied electrode composite layer-forming liquid composition spread (i.e., leveling) and merge with adjacent droplets.

In the droplets of the electrode composite layer-forming liquid composition immediately after application, a solvent 3, an active material 4, and a binder 5 are uniformly dispersed. The solid components in the electrode composite layer-forming liquid composition settle over time according to the Stokes' law, which is expressed by the particle diameter, specific gravities, and viscosity of the electrode composite layer-forming liquid composition. In the electrode composite layer-forming liquid composition including the active material and the binder, the settling velocity of the active material is higher because of a higher specific gravity and a large particle diameter. Therefore, in the electrode composite layer-forming liquid composition after being applied onto the base, the active material settles first and loses fluidity. The electrode composite layer-forming liquid composition concurrently spreads on the base and merges with adjacent droplets. When inkjet is used as a liquid discharge means, the active material in a droplet discharged from a discharge head tends to concentrate at a location directly below a droplet discharge position, and thus the binder concentration becomes relatively high in a region between the discharge heads that is formed as a result of merging of the droplets. The loss of fluidity due to settling proceeds continuously over time, and thus continuous and periodic variation of the binder concentration is formed.

If the viscosity of the electrode composite layer-forming liquid composition is too low, the electrode composite layer-forming liquid composition and thus the active material in the electrode composite layer-forming liquid composition will immediately spread in the X or Y direction due to the impact of landing on the base. In such a case, the active material tends not to remain at the location directly below the liquid discharge position, and thus an electrode composite layer having a periodic binder concentration may not be formed. Furthermore, there is a risk that a periodic binder concentration distribution cannot be obtained due to influence of unevenness of drying by using heat transfer convection in an electrode composite layer-forming liquid composition drying step.

Therefore, the viscosity of the electrode composite layer-forming liquid composition (at rotation speed of 100 rpm) is preferably 20 cp or more, more preferably 30 cp or more, and particularly preferably 40 cp or more.

The electrode composite layer-forming liquid composition is preferably a thixotropic fluid.

The thixotropy index of the electrode composite layer-forming liquid composition, defined as viscosity at 10 rpm/viscosity at 100 rpm, is preferably 1.2 or more, more preferably 1.5 or more, and particularly preferably 2.0 or more. In addition, the thixotropy index of the electrode composite layer-forming liquid composition is preferably 10 or less, and more preferably 5 or less, for eliminating the problem of poor productivity due to a long waiting time required for merging after landing.

In this specification, the average binder concentration in the electrode composite layer is referred to as “C_{AVE}”, the average binder concentration in the region A_{High} is referred to as “C_{High}”, and the average binder concentration in the region A_{Low} is referred to as “C_{Low}”. Note that C_{High} and C_{Low} are both average binder concentrations of the respective regions for one period.

Here, the ratio of C_{High} to C_{Low} (C_{High}/C_{Low}) is not particularly limited and can be appropriately selected according to a purpose. However, the ratio is preferably 1.2 or more, more preferably 1.5 or more, and even more preferably 2.0 or more, because these ranges of the ratio result in efficient binding, thereby improving cycle characteristics. In addition, for preventing generation of Li dendrites, the ratio is preferably 10 or less, more preferably 5 or less, and even more preferably 3 or less. The ratio of C_{High} to C_{Low} (C_{High}/C_{Low}) is calculated using values of respective regions derived from the same cycle.

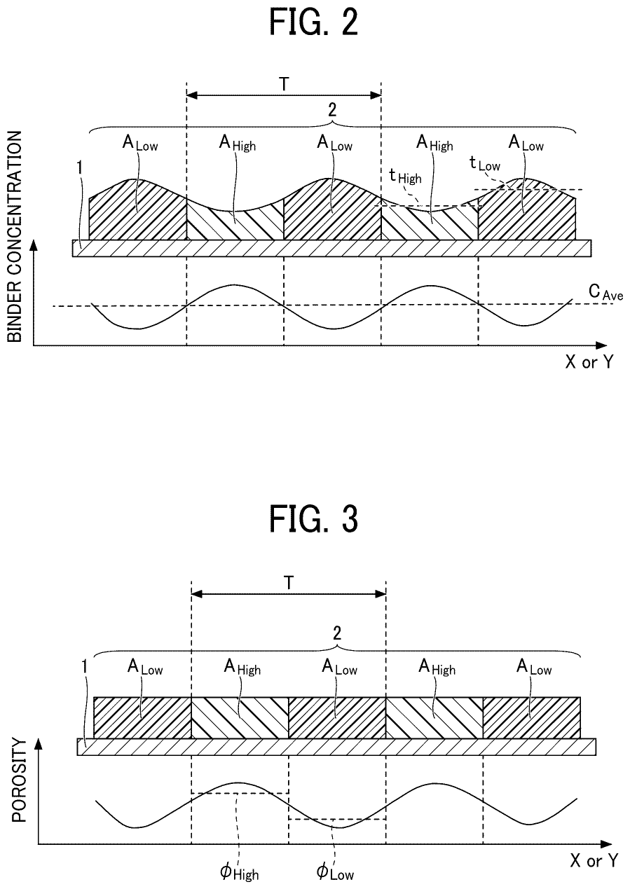

FIG. 2 is a schematic cross-sectional view of an electrode according to an embodiment of the present disclosure.

In this specification, the average thickness in the region A_{High} is referred to as “t_{High}” and the average thickness in the region A_{Low} is referred to as “Low”. Note that the average thickness t_{High} and the average thickness t_{Low} are both the average thicknesses of the respective regions for one period.

In the electrode of the present disclosure, the average thickness t_{High} of the region A_{High} and the average thickness t_{Low} of the region A_{Low} preferably satisfy the following Expression (1).

$${t}_{High} < {t}_{low} \qquad Expression ( 1 )$$

When the average thickness of each region in the electrode of the present disclosure satisfies Expression (1), an electrode having excellent cycle characteristics and rate characteristics can be obtained. The mechanism is unclear, but is speculated as follows.

Expansion and contraction of the active material caused by the charge and discharge reaction proceeds first at the region A_{Low} having a low concentration of the binder that is a resistance component, and thus the stress strain in the electrode composite layer is concentrated in the region A_{High}. The region A_{High} has a high binder concentration and is thus relatively highly resistant to the stress strain. When the average thickness of each region in the electrode of the present disclosure satisfies Expression (1), the space formed above the region A_{High} may serve as a buffer layer for relieving stress strain, resulting in better cycle characteristics. In addition, the buffer layer facilitates permeation of the electrolyte, resulting in excellent rate characteristics.

In the electrode of the present disclosure, the average thickness t_{High} in the region A_{High} and the average thickness t_{Low} in the region A_{Low} preferably change continuously, and more preferably change in a curved manner, for preventing damage to the electrode composite layer.

The average thickness in each region A changing in a curved manner can be confirmed by obtaining a surface profile using, for example, a laser microscope or a stylus profilometer.

The ratio of the average thickness t_{High} to the average thickness t_{Low} (t_{High}/t_{Low}) is not particularly limited and can be appropriately selected according to a purpose. For preventing damage to the electrode composite layer, t_{High}/t_{Low} is preferably 0.5 or more, and more preferably 0.7 or more. For efficiently relaxing the stress strain, t_{High}/t_{Low} is preferably 0.95 or less, and more preferably 0.9 or less. Note that the ratio of the average thickness t_{High} to the average thickness t_{Low} (t_{High}/t_{Low}) is calculated using values derived from the same period.

The method for measuring the average thickness of the electrode composite layer is not particularly limited and can be appropriately selected according to a purpose. Here is an example of such a method.

### —Method A: Case of Binder Containing Characteristic Element—

Type 53 epoxy resin for embedding (Lot No. 53512040149, SANKEI CO., LTD.) as a base material and a curing agent (Lot No. 53572040342, SANKEI CO., LTD.) are thoroughly mixed (volume ratio: 1:2), and an electrode composite layer is embedded in the resin using a vacuum impregnation device (BUEHLER VACUUM IMPREGNATION EQUIPMENT I, SANKEI CO., LTD.) and allowed to harden for 24 hours. The electrode composite layer embedded in the epoxy resin is processed with CROSS SECTION POLISHER (manufactured by JEOL LTD.), a cross section of the electrode composite layer is observed with a desktop scanning electron microscope SEM/EDX (PHENOM PROX, manufactured by JASCO INTERNATIONAL CO., LTD.), and element mapping on the cross section is conducted. If the binder does not contain any characteristic element, but the binder can be stained by using electron staining with osmium tetroxide or ruthenium tetroxide, element mapping is conducted by using this method.

The average binder concentration C_{AVE} of the entire cross section of the electrode composite layer, and the binder concentrations in the X direction or Y direction are calculated by averaging in the thickness (Z) direction. The region is divided into the region A_{High} having a binder concentration higher than the average binder concentration C_{AVE} and the region A_{Low} having a binder concentration lower than the average binder concentration C_{AVE}, and the average thickness t_{High} of the region A_{High} and the average thickness t_{Low} of the region A_{Low} are calculated.

### —Method B: Case of Binder Not Containing Characteristic Element—

The electrode composite layer is cut using a surface and interfacial cutting analysis system (SAICAS) at intervals that are 1/10 of the period intended for the production method, and the collected samples are subjected to pyrolysis GC/MS analysis to obtain peak values for fragments from the binder. These peak values are applied to a calibration curve obtained using known binder concentrations to quantify the binder concentration. The period is calculated by plotting the binder concentration in each sample. The cutting depths by SAICAS upon reaching the base (film thickness) are acquired and associated with the calculated period, to calculate the average thickness t_{High} of the region A_{High} and the average thickness t_{Low} of the region A_{Low}.

FIG. 3 is a schematic cross-sectional view of an electrode according to an embodiment of the present disclosure.

In this specification, the average porosity in the region A_{High} is referred to as “(High”, and the average porosity in the region A_{Low} is referred to as “φ_{Low}”. Note that the average porosity φ_{High} and the average porosity φ_{Low} are both the average porosities of the respective regions for one period.

In the electrode of the present disclosure, the average porosity φ_{High} in the region A_{High} and the average porosity φ_{Low} in the region A_{Low} preferably satisfy the following Expression (2).

$${φ}_{High} > {φ}_{Low} \qquad Expression ( 2 )$$

When the average porosity of each region in the electrode of the present disclosure satisfies Expression (2), an electrode having excellent cycle characteristics and rate characteristics can be obtained. In addition, compared to the electrode satisfying Expression (1), the overall average thickness of the electrode composite layer can be reduced, which results in improved volume energy density. The mechanism is unclear, but is speculated as follows.

Expansion and contraction of the active material caused by the charge and discharge reaction proceeds first at the region A_{Low} having a low concentration of the binder that is a resistance component, and thus the stress strain in the electrode composite layer is concentrated in the region A_{High}. The region A_{High} has a high binder concentration and is thus relatively highly resistant to the stress strain. When, in the electrode of the present disclosure, the average porosity φ_{High} in the region A_{High} and the average porosity φ_{Low} in the region A_{Low} satisfy Expression (2), function of a buffer layer for relaxing stress strain is achieved, resulting in better cycle characteristics. In addition, the buffer layer facilitates permeation of the electrolyte, resulting in excellent rate characteristics.

In the electrode of the present disclosure, the average porosity φ_{High} of the region A_{High} and the average porosity φ_{Low} of the region A_{Low} preferably change continuously, for preventing damage to the electrode composite layer.

In this specification, the phrase “the average porosity φ_{High} of the region A_{High} and the average porosity φ_{Low} of the region A_{Low} change continuously” means that the average porosity gradually changes from the region A_{High} to the region A_{Low} in at least one direction perpendicular to the thickness direction of the electrode composite layer 2. The electrode composite layer 2 of the present embodiment should be distinguished from a layer in which there is significant difference in average porosity (discontinuity), for example in the case where two active material layers with different average porosities are adjacent to each other. That is, the phrase indicates that there is no boundary, i.e., no interface, formed by significantly different average porosities.

The continuous change in average porosity in each region can be confirmed, for example, by observing a cross section of the electrode composite layer using a SEM.

The ratio of the average porosity φ_{High} to the average porosity φ_{Low} (φ_{High}/φ_{Low}) is not particularly limited and can be appropriately selected according to a purpose. For preventing damage to the electrode composite layer, φ_{High}/φ_{Low} is preferably 1.5 or less, and more preferably 0.13 or less. For efficiently relaxing the stress strain, φ_{High}/φ_{Low} is preferably 1.1 or more, and more preferably 1.2 or less. Note that the ratio of the average porosity φ_{High} to the average porosity φ_{Low} (φ_{High}/φ_{Low}) is calculated using values derived from the same period.

The method for measuring the average porosity of the electrode composite layer is not particularly limited and can be appropriately selected according to a purpose. Here is an example of such a method.

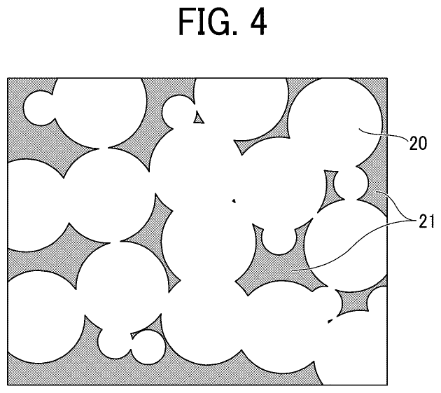

Type 53 epoxy resin for embedding (Lot No. 53512040149, SANKEI CO., LTD.) as a base material and a curing agent (Lot No. 53572040342, SANKEI CO., LTD.) are thoroughly mixed (volume ratio: 1:2), and an electrode composite layer is embedded in the resin using a vacuum impregnation device (BUEHLER VACUUM IMPREGNATION EQUIPMENT I, SANKEI CO., LTD.) and allowed to harden for 24 hours. The electrode composite layer embedded in the epoxy resin is processed with CROSS SECTION POLISHER (manufactured by JEOL LTD.), a cross section of the electrode composite layer is observed with a desktop scanning electron microscope SEM/EDX (PHENOM PROX, manufactured by JASCO INTERNATIONAL CO., LTD.), and a SEM image of the electrode composite layer is obtained. The obtained SEM image of the electrode composite layer is binarized (see FIG. 4) using image processing software (IMAGE-PRO PREMIER version 9.2 64-bit, HAKUTO CO., LTD.) to determine the area of regions associated with particles and the area of regions associated with voids. Then, the porosity is calculated by dividing the area associated with voids by the total area. In binarization using software, for example, regions in a binarized image with a density of more than 50% may be determined as particles or voids, and regions with a density of 50% or less may be determined as voids or particles.

For improving cycle characteristics and rate characteristics, the electrode composite layer of the present disclosure preferably satisfies at least one of Expression (1) and Expression (2).

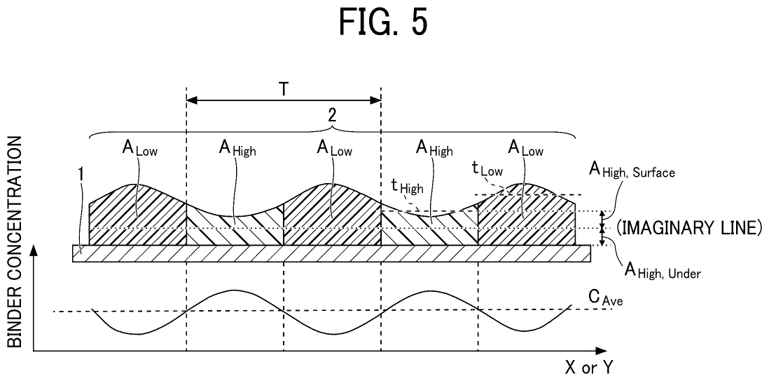

FIG. 5 is a schematic cross-sectional view of an electrode according to an embodiment of the present disclosure.

In this specification, with respect to an imaginary line equally dividing, in two, the average thickness t_{High} and extending in a direction perpendicular to the thickness direction of the electrode composite layer, the region on the base side of the electrode composite layer is referred to as a “region A_{High, Under}”, and the region not on the base side of the electrode composite layer is referred to as a “region A_{High, surface}”.

It is preferable that the average binder concentration C_{High, Under} of the region A_{High, Under} and the average binder concentration C_{High, surface} of the region A_{High, surface} satisfy the following Expression (3).

$${C}_{High , Under} < {C}_{High , surface} \qquad Expression ( 3 )$$

Note that the average binder concentration C_{High, Under} and the average binder concentration C_{High, surface} are both average binder concentrations of the respective regions for one period.

When the average binder concentration in each region of the electrode of the present disclosure satisfies Expression (3), an electrode having excellent cycle characteristics can be obtained. The mechanism is unclear, but is speculated as follows.

Expansion and contraction of the active material caused by the charge and discharge reaction proceeds first at the region A_{Low} having a low concentration of the binder that is a resistance component, and thus the stress strain in the electrode composite layer is concentrated in the region A_{High}. In contrast to the region A_{High, Under}, the region A_{High, surface} is not bonded to a base or the like and thus more susceptible to the effects of expansion and contraction. Therefore, by satisfying Expression (3), stronger film strength can be achieved, and as a result, excellent cycle characteristics can be achieved.

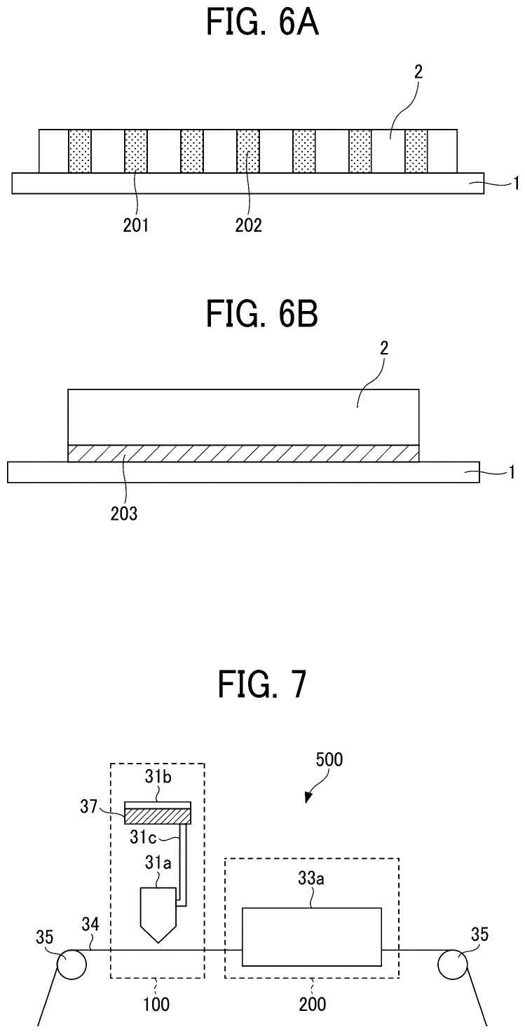

FIG. 6A is a schematic cross-sectional view of an electrode according to an embodiment of the present disclosure.

The electrode composite layer 2 may have an opening 201 as illustrated in FIG. 6A. The number of openings 201 is preferably one or more, and more preferably two or more.

The opening 201 may be a hole extending through the electrode composite layer from a surface of the electrode composite layer to a surface of the base, or may be a non-through hole not reaching a surface of the base.

The opening 201 may be hollow or filled with a material 202. When the opening 201 is filled with the material 202, the material 202 may be a single type of material or a mixture of two or more types of materials, and in either case, the material(s) is different from the material that forms the electrode composite layer. For improving ion conductivity, the material 202 is preferably a material including a solid electrolyte.

The electrode composite layer having the openings 201 can be suitably produced by using an inkjet as an electrode composite layer forming device, because application control in inkjet processing is easy.

FIG. 6B is a schematic cross-sectional view of an electrode according to an embodiment of the present disclosure.

As illustrated in FIG. 6B, the electrode may include, between the base 1 and the electrode composite layer 2, a bonding layer 203 containing a metal to be alloyed with lithium.

### (Method for Producing Electrode and Apparatus for Producing Electrode)

A method for producing an electrode of the present disclosure is a method for producing an electrode including an electrode composite layer forming step, and the electrode composite layer forming step includes an electrode composite layer-forming liquid composition applying step and an electrode composite layer-forming liquid composition drying step, and may include another step as necessary.

An apparatus for producing an electrode of the present disclosure is an apparatus for producing an electrode including an electrode composite layer forming device, and the electrode composite layer forming device includes an electrode composite layer-forming liquid composition applying unit and an electrode composite layer-forming liquid composition drying unit, and may include another device and/or unit as necessary.

The method for producing an electrode can be suitably implemented by the apparatus for producing an electrode, the electrode composite layer forming step can be suitably implemented by the electrode composite layer forming device, the electrode composite layer-forming liquid composition applying step can be suitably implemented by the electrode composite layer-forming liquid composition applying unit, the electrode composite layer-forming liquid composition drying step can be suitably implemented by the electrode composite layer-forming liquid composition drying unit, and the other steps can be suitably implemented by the other devices and/or units.

In the electrode composite layer obtained in the electrode composite layer forming step, the binder concentration of the electrode composite layer varies periodically and continuously in at least one direction perpendicular to the thickness direction of the electrode composite layer.

### <Electrode Composite Layer Forming Step and Electrode Composite Layer Forming Device>

The electrode composite layer forming step is a step of forming an electrode composite layer on a base. The electrode composite layer forming step includes the electrode composite layer-forming liquid composition applying step and the electrode composite layer-forming liquid composition drying step.

The electrode composite layer forming device is a device for forming an electrode composite layer on a base. The electrode composite layer forming device includes the electrode composite layer-forming liquid composition applying unit and the electrode composite layer-forming liquid composition drying unit.

### <<Electrode Composite Layer-Forming Liquid Composition Applying Step, Electrode Composite Layer-Forming Liquid Composition Applying Unit>>

The electrode composite layer-forming liquid composition applying step is a step of applying, onto the base, an electrode composite layer-forming liquid composition containing an active material, a binder, and a dispersion medium.

The electrode composite layer-forming liquid composition applying unit is a unit for applying, onto the base, an electrode composite layer-forming liquid composition containing an active material, a binder, and a dispersion medium.

The electrode composite layer-forming liquid composition applying unit is not particularly limited and can be appropriately selected according to a purpose. Examples of the electrode composite layer-forming liquid composition applying unit include, but are not limited to, those employing liquid discharge methods such as an inkjet method, a spray coating method, and a dispenser method, a spin coating method, a casting method, a microgravure coating method, a gravure coating method, a bar coating method, a roll coating method, a wire bar coating method, a dip coating method, a slit coating method, a capillary coating method, a nozzle coating method, a gravure printing method, a screen printing method, a flexographic printing method, an offset printing method, and a reverse printing method. Among these, the liquid discharge method is preferable, and the ink jet method is more preferable.

When a liquid discharge method is employed by the electrode composite layer-forming liquid composition applying unit, an electrode having a binder concentration that varies periodically and continuously can be easily obtained. In particular, the inkjet method can be used to produce an electrode having periodical and continuous variation of binder concentration in any pattern in the XY plane. Another advantage is that the electrodes can be produced in a non-contact manner and in any shape, and thus it is possible to reduce loss of the active material during die cutting in the electrode production process.

### <<<Electrode Composite Layer-Forming Liquid Composition>>

The electrode composite layer-forming liquid composition contains the active material, the binder, and the dispersion medium, and may include a conductive auxiliary agent, a dispersant, a solid electrolyte, and another component as necessary.

The active material, binder, conductive auxiliary agent, and solid electrolyte can be the same as those in the (Electrode) section, so duplicated descriptions will be omitted.

### —Dispersion Medium—

The dispersion medium is not particularly limited and can be appropriately selected according to a purpose. Examples of the dispersion medium include, but are not limited to, aqueous dispersion media such as water, ethylene glycol, and propylene glycol; amide dispersion media such as N-methyl-2-pyrrolidone, 2-pyrrolidone, and N,N-dimethylacetamide; ketone dispersion media such as cyclohexanone; ester dispersion media such as butyl acetate, butyl butyrate, isobutyl isobutyrate, methyl hexanoate, ethyl octanoate, and ethyl decanoate; aromatic dispersion media such as mesitylene; and alcoholic dispersion media such as 2-n-butoxymethanol and 2-dimethylethanol.

When a positive electrode active material is contained as the active material, an amide dispersion medium, an ester dispersion medium, or a ketone dispersion medium is preferred for achieving excellent dispersibility.

When a sulfide solid electrolyte is contained as another component, an ester compound is preferable, and it is more preferable that the ester compound has a group on the carbonyl group carbon side selected from straight chain alkyl groups and branched alkyl groups having 3 or more carbon atoms, and a methyl group or an ethyl group on the carbonyl group oxygen side.

These dispersion media may be used alone or in combination of two or more types. The binder contained in the electrode composite layer-forming liquid composition preferably has a smaller specific gravity than that of the active material, for achieving variation of the binder concentration in the electrode composite layer. Specifically, the ratio of the specific gravity of the active material to the specific gravity of the binder is preferably 1.5 times or more, and more preferably 2 times or more.

The method for measuring the specific gravity is not particularly limited and can be appropriately selected according to a purpose. For example, the true density of the active material or binder may be measured using a pycnometer method in accordance with JIS K 7112 B method standard, and the ratio of the resulting true density to the true density of the solvent may be calculated as the specific gravity.

The binder included in the electrode composite layer-forming liquid composition is preferably dissolved in the dispersion medium, for obtaining an electrode satisfying Expression (3) and having improved cycle characteristics.

The dispersion medium preferably has a boiling point under a normal pressure condition.

The boiling point of the dispersion medium is not particularly limited and can be appropriately selected according to a purpose. For achieving excellent storage stability and handling properties, the boiling point is preferably 100° C. or higher, more preferably 120° C. or higher, and even more preferably 150° C. or higher. For achieving quick drying in the drying step, the boiling point of the dispersion medium is preferably 300° C. or less, more preferably 250° C. or less, and even more preferably 200° C. or less.

When a positive electrode active material is used as the active material, the water content of the dispersion medium is preferably 2,000 ppm or less, and more preferably 1,000 ppm or less.

When a sulfide solid electrolyte is contained as another component, the water content of the dispersion medium is preferably 100 ppm or less, and more preferably 50 ppm or less.

The method for measuring the water content in the dispersion medium is not particularly limited and may be appropriately selected according to a purpose. For example, the water content can be measured by Karl Fischer water content measurement by coulometric titration at 25° C. using water vaporization. The measuring device is not particularly limited and can be appropriately selected according to a purpose. For example, a Karl Fischer trace moisture meter (CA-200, manufactured by NITTOSEIKO ANALYTECH CO., LTD.) can be used.

### [Viscosity]

The viscosity of the electrode composite layer-forming liquid composition is not particularly limited and may be appropriately selected according to a purpose. Under measurement conditions of 25° C. and a rotation speed of 100 rpm, the viscosity of the electrode composite layer-forming liquid composition is preferably 20 mPa·s or more and 200 mPa·s or less, more preferably 30 mPa·s or more and 100 mPa·s or less, and even more preferably 40 mPa·s or more and 70 mPa·s or less.

When the steady flow shear viscosity (25° C., rotation speed: 100 rpm) of the electrode composite layer-forming liquid composition is 20 mPa·s or more, drying unevenness is prevented in the drying step, making it easier to form an electrode having a periodic binder concentration.

When the steady flow shear viscosity (25° C., rotation speed: 100 rpm) of the electrode composite layer-forming liquid composition is 200 mPa·s or less, discharge performance upon discharging from a liquid discharge head can be improved.

The method for measuring the viscosity of the electrode composite layer-forming liquid composition is not particularly limited and can be appropriately selected according to a purpose. For example, the viscosity can be measured in accordance with JIS Z 8803. A device used for measuring the viscosity is not particularly limited and can be appropriately selected according to a purpose. Examples of the device include, but are not limited to, a TV25 type viscometer (cone plate viscometer, manufactured by TOKI SANGYO CO., LTD).

### [Solid Content Concentration]

The solid content concentration of the electrode composite layer-forming liquid composition is not particularly limited and can be appropriately selected according to a purpose, and is preferably 40 mass % or more, more preferably 50 mass % or more, and even more preferably 60 mass % or more.

The solid content concentration of 40 mass % or more in the electrode composite layer-forming liquid composition improves thixotropic quality of the composition, and thus improves dispersion stability and prevents flowing of the composition during the step of drying the applied electrode composite layer-forming liquid composition. Thus, unevenness in film thickness and composition due to drying is prevented, and an electrode with the desired periodic binder concentration can be easily obtained. Furthermore, the required drying time can be shortened, and thus improved productivity, reduced environmental impact, and associated cost reduction effects can be achieved.

In this specification, the “solid content concentration of the electrode composite layer-forming liquid composition” refers to the mass percentage of the mass of the components contained in the composition, excluding the dispersion medium and water, relative to the total mass of the electrode composite layer-forming liquid composition.

The method for measuring the solid content concentration of the electrode composite layer-forming liquid composition is not particularly limited and may be appropriately selected according to a purpose. For example, when the composition of the electrode composite layer-forming liquid composition is known, a method using the following Equation (4) may be used; and when the composition of the electrode composite layer-forming liquid composition is unknown, a measurement method in accordance with JIS K5601-1-2 may be used.

Solid Content Concentration={Total Solids(Parts by Mass)/(Total Solids(Parts by Mass)+Dispersion Medium(Parts by Mass)+Water(Parts by Mass))}×100(%) (Equation 4)

The device used to measure the solid content concentration of the electrode composite layer-forming liquid composition is not particularly limited and can be appropriately selected according to a purpose. For example, a heat-drying type solids meter (MX-50, manufactured by A&D COMPANY, LIMITED) can be used.

### [Method for Producing Electrode Composite Layer-Forming Liquid Composition]

The electrode composite layer-forming liquid composition can be produced by dissolving or dispersing components in a dispersion medium. Specifically, the electrode composite layer-forming liquid composition can be produced by mixing the components with the dispersion medium using a mixer such as a ball mill, sand mill, bead mill, pigment disperser, mortar machine, ultrasonic disperser, homogenizer, planetary mixer, or FILMIX.

In the electrode composite layer-forming liquid composition applying step, the period of applying the electrode composite layer-forming liquid composition onto the base is not particularly limited and can be appropriately selected according to a purpose. However, the period is preferably 0.2 mm or more and 2.5 mm or less, because the period within this range ensures prevention of detachment of the active material from the obtained electrode composite layer and the growth of Li dendrites and thus results in excellent cycle characteristics. In addition, for achieving efficiently binding the active material, the period is preferably 0.4 mm or more, more preferably 0.6 mm or more, and is preferably 1.7 mm or less, more preferably 1.3 mm or less.

When the period in the electrode composite layer-forming liquid composition applying step is 0.2 mm or more, it is possible to eliminate the problem of insufficient binding quality at the same or a similar level compared to an electrode having a uniform binder concentration, which results in poor cycle characteristics or another insufficient effect.

When the period in the electrode composite layer-forming liquid composition applying step is 2.5 mm or less, it is possible to eliminate the problem of insufficient binding of the active material in a region with a low binder concentration.

### <<Electrode Composite Layer-Forming Liquid Composition Drying Step, Electrode Composite Layer-Forming Liquid Composition Drying Device>>

The electrode composite layer-forming liquid composition drying step is a step of drying the applied electrode composite layer-forming liquid composition.

The electrode composite layer-forming liquid composition drying device is a device for drying the applied electrode composite layer-forming liquid composition.

The electrode composite layer-forming liquid composition drying device is not particularly limited and can be appropriately selected according to a purpose. Examples of the device include, but are not limited to, an IR heater and a hot air heater.

In the electrode composite layer-forming liquid composition drying step, it is preferable to dry the electrode composite layer-forming liquid composition applied to the base before the composition becomes flat, for obtaining an electrode satisfying Expression (1) and having improved rate characteristics and improved cycle characteristics.

In this specification, “become flat” refers to a state in which applied droplets of the electrode composite layer-forming liquid composition merges with adjacent droplets to form a film with a uniform thickness.

The drying temperature in the electrode composite layer-forming liquid composition drying step is not particularly limited and can be appropriately selected according to a purpose. However, the drying temperature preferably is a temperature at which the vapor pressure of the solvent for forming an electrode composite layer is 10³ Pa or more and 10⁵ Pa or less.

By using the temperature at which the vapor pressure of the solvent for forming an electrode composite layer is 10³ Pa or more, the time required for drying is shortened, improving productivity and preventing occurrence of composition unevenness.

By using the temperature at which the vapor pressure of the solvent for forming an electrode composite layer is 10⁵ Pa or less, it is possible to eliminate the problem of pinholes due to air bubbles formed inside the electrode composite layer-forming liquid composition applied to the base.

When the solvent for forming an electrode composite layer is a mixture of two or more kinds of solvents, the vapor pressure of the mixed solvent may be calculated based on the Raoult's law. The method for measuring the vapor pressure is not particularly limited and can be appropriately selected according to a purpose. Examples of the method include, but are not limited to, the static method, the boiling point method, the isoteniscope method, the gas flow method, and the DSC method. The vapor pressure can also be calculated based on Antoine equation.

### <<Another Step and Another Device>>

The other step is not particularly limited and can be appropriately selected according to a purpose. Examples of the other step include, but are not limited to, a waiting step and a pressing step.

The other device is not particularly limited and can be appropriately selected according to a purpose. Examples of the other device include, but are not limited to, a pressing device.

The waiting step is a step of waiting for a certain period of time after the electrode composite layer-forming liquid composition applying step and before the electrode composite layer-forming liquid composition drying step.

During the waiting step, the active material in the applied electrode composite layer-forming liquid composition is allowed to settle sufficiently. The sufficient settlement of the composition facilitates production of electrodes satisfying Expression (3) and thus having improved cycle characteristics.

The “certain period of time” in the waiting step is not particularly limited and may be appropriately selected according to a purpose as long as the period is shorter than a time required for flattening of the applied electrode composite layer-forming liquid composition, and may be, for example, 1 second or more and 300 seconds or less.

The pressing step is a step of pressing the obtained electrode after the electrode composite layer-forming liquid composition drying step.

The pressing device is a device for pressing the obtained electrode.

The pressing step facilitates production of electrodes satisfying Expression (2) and thus having an improved volumetric energy, improved rate characteristics, and improved cycle characteristics.

The pressing device is not particularly limited and can be appropriately selected according to a purpose. Examples of the pressing device include, but are not limited to, a uniaxial pressing device, an isostatic pressing device, and a roll pressing device. Among these, a roll pressing device is preferred from the viewpoint of productivity.

The pressing conditions are not particularly limited and can be appropriately selected according to a purpose. It is preferable to adjust pressing pressure and a gap so that the volume density of the electrode composite layer falls within a range according to a desired battery design.

In the case of the positive electrode composite layer, for reducing the electronic resistance in the electrode composite layer, the volume density is preferably 2.0 g/cm³ or more, more preferably 2.5 g/cm³ or more, and even more preferably 3.0 g/cm³ or more. For ensuring a porosity that allows the electrolyte to permeate, the volume density is preferably 4.0 g/cm³ or less, and more preferably 3.5 g/cm³ or less.

For example, in a case where a positive electrode composite layer applied onto a base having an average thickness of 15 μm to have a basis weight of 20 mg/cm² is processed to have a volume density of 3.0 g/cm³, pressing may be performed such that 67 μm is achieved (≈20 mg/cm²×3.0 g/cm³). Thus, the gap of the roll press is set to 82 μm (=67 μm+the base thickness), and a load of, for example, 7 tons is applied as a pressing pressure sufficient to crush the electrode composite layer.

For the negative electrode composite layer, for reducing the electronic resistance in the negative electrode composite layer, the volume density is preferably 1.0 g/cm³ or more, and more preferably 1.5 g/cm³ or more. For ensuring a porosity that allows the electrolyte to permeate, the volume density is preferably 3.0 g/cm³ or less.

Here, an embodiment of the present disclosure will be described with reference to the drawings. However, the present disclosure is not limited to these embodiments in any way.

In each drawing, the same reference numerals are given to the same components, and redundant explanation may be omitted. Further, the numbers, positions, shapes, and the like of constituent members are not limited to the present embodiment, and may include any numbers, positions, shapes, and the like that are preferable for implementing the present disclosure.

[Embodiment for Forming Electrode Composite Layer by Direct Application of Electrode Composite Layer-Forming Liquid Composition onto Base]

FIG. 7 is a schematic diagram of an apparatus for producing an electrode according to an embodiment of the present disclosure.

An apparatus 500 for producing an electrode is an apparatus for producing an electrode composite layer by using the electrode composite layer-forming liquid composition. The apparatus 500 for producing an electrode includes a printing unit 100 that applies an electrode composite layer-forming liquid composition 37 onto a print base 34 to form an electrode composite layer-forming liquid composition layer, and if desired, the apparatus 500 for producing an electrode includes a heating unit 200. The apparatus 500 for producing an electrode includes a conveyance unit 35 that conveys the print base 34. The conveyance unit 35 conveys the print base 34 at a speed set in advance to the printing unit 100, and optionally to the heating unit 200 in this order.

### —Printing Unit 100—

The printing unit 100 includes a printing device 31a, which is an example of the electrode composite layer-forming liquid composition applying unit for applying, on the print base 34, the electrode composite layer-forming liquid composition 37 for forming the electrode composite layer, a storage container 31b that accommodates the electrode composite layer-forming liquid composition 37, and a supply tube 31c that supplies the electrode composite layer-forming liquid composition 37 stored in the storage container 31b to the printing device 31a.

The storage container 31b accommodates the electrode composite layer-forming liquid composition 37. The printing unit 100 discharges the electrode composite layer-forming liquid composition 37 from the printing device 31a to form, on the print base 34, an electrode composite layer-forming liquid composition layer as a thin film. The storage container 31b may be integrally formed with the apparatus for producing an electrode, or may be removable from the apparatus for producing an electrode. Further, the storage container 31b may be a container used for addition to a storage container integrally formed with the apparatus for producing an electrode or a storage container removable from the apparatus for producing an electrode.

The storage container 31b and the supply tube 31c can be freely selected, as long as the storage container 31b and the supply tube 31c can stably store and supply the electrode composite layer-forming liquid composition 37.

### —Heating Unit 200—

As illustrated in FIG. 7, the heating unit 200 has a heating device 33a, and performs an electrode composite layer-forming liquid composition drying step in which the electrode composite layer-forming liquid composition layer formed by the printing unit 100 is heated by the heating device 33a to dry the remaining liquid. Thus, an electrode composite layer can be formed. The heating unit 200 may remove the liquid under reduced pressure.

The heating device 33a is not particularly limited and can be appropriately selected according to a purpose. Examples of the heating device 33a include, but are not limited to, an IR heater and a hot air heater.

The heating temperature and time can be appropriately selected in accordance with the boiling point of the liquid contained in the electrode composite layer-forming liquid composition layer and the thickness of the film to be formed.

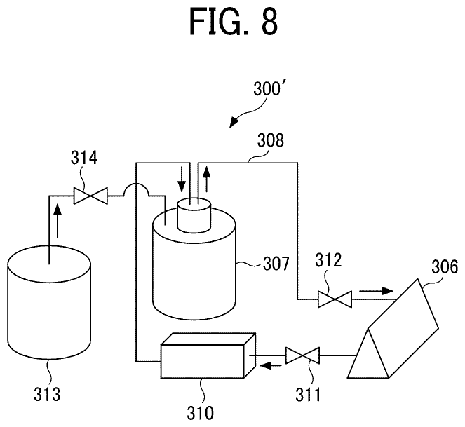

FIG. 8 is a schematic diagram of an apparatus for producing an electrode according to an embodiment of the present disclosure.

A liquid discharge device 300′ can control a pump 310, a valve 311, and a valve 312 to circulate the electrode composite layer-forming liquid composition in a liquid discharge head 306, a tank 307, and a tube 308.

The liquid discharge device 300′ includes an external tank 313. When the amount of the electrode composite layer-forming liquid composition in the tank 307 decreases, the liquid discharge device 300′ may control the pump 310, the valve 311, the valve 312, and a valve 314 to supply the electrode composite layer-forming liquid composition from the external tank 313 to the tank 307.

By using the above-described apparatus for producing an electrode, the electrode composite layer-forming liquid composition can be discharged to a targeted location of a base.

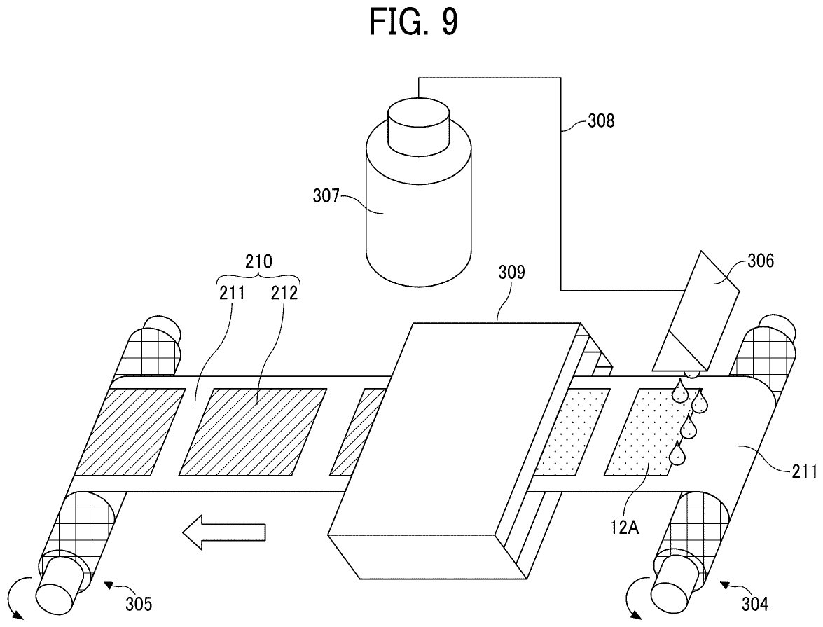

FIG. 9 is a schematic diagram of an apparatus for producing an electrode according to an embodiment of the present disclosure.

The method for producing an electrode includes a step of sequentially discharging an electrode composite layer-forming liquid composition 12A onto a base 211 by using a liquid discharge device.

First, the base 211 having an elongated shape is provided. The base 211 is wound around a tubular core and set on an unwinding roller 304 and a wind-up roller 305 so that a side on which the electrode composite layer is to be formed faces upward in FIG. 9. Here, the unwinding roller 304 and the wind-up roller 305 rotate counterclockwise in FIG. 9 to convey the base 211 from right to left in FIG. 9. The liquid discharge head 306 disposed above the base 211 between the unwinding roller 304 and the wind-up roller 305 discharges droplets of the electrode composite layer-forming liquid composition 12A onto the base 211 that is sequentially conveyed, similarly to FIG. 7.

The liquid discharge head 306 may be provided as a plurality of liquid discharge heads 306 in a direction substantially parallel or substantially perpendicular to the conveyance direction of the base 211. Next, the base material 211 onto which the droplets of the electrode composite layer-forming liquid composition 12A are discharged is conveyed to a heating unit 309 by the unwinding roller 304 and the wind-up roller 305. As a result, an electrode composite layer 212 is formed, and an electrode 210 in which the electrode composite layer 212 is provided on the base 211 is obtained.

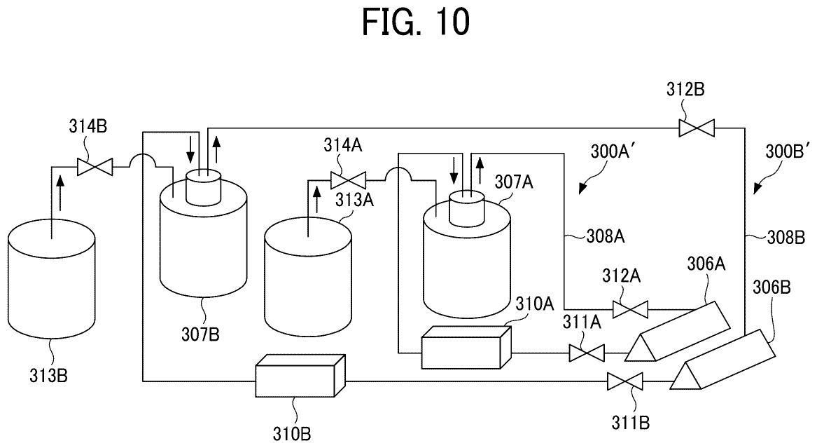

FIG. 10 is a schematic diagram of a variation of an apparatus for producing an electrode according to an embodiment of the present disclosure.

As illustrated in FIG. 10, a liquid discharge device 300A′ and a liquid discharge device 300B′ may be used in combination. That is, the electrode composite layer-forming liquid composition may be supplied from an external tank 313A and an external tank 313B connected to a tank 307A and a tank 307B, and the liquid discharge head may include a plurality of heads including a head 306A and a head 306B. Accordingly, a tube 308A and a tube 308B, a valve 311A and a valve 311B, a valve 312A and a valve 312B, a valve 314A and a valve 314B, and a pump 310A and a pump 310B may be provided.

[Embodiment for Forming Electrode Composite Layer by Indirect Application of Electrode Composite Layer-Forming Liquid Composition onto Base]

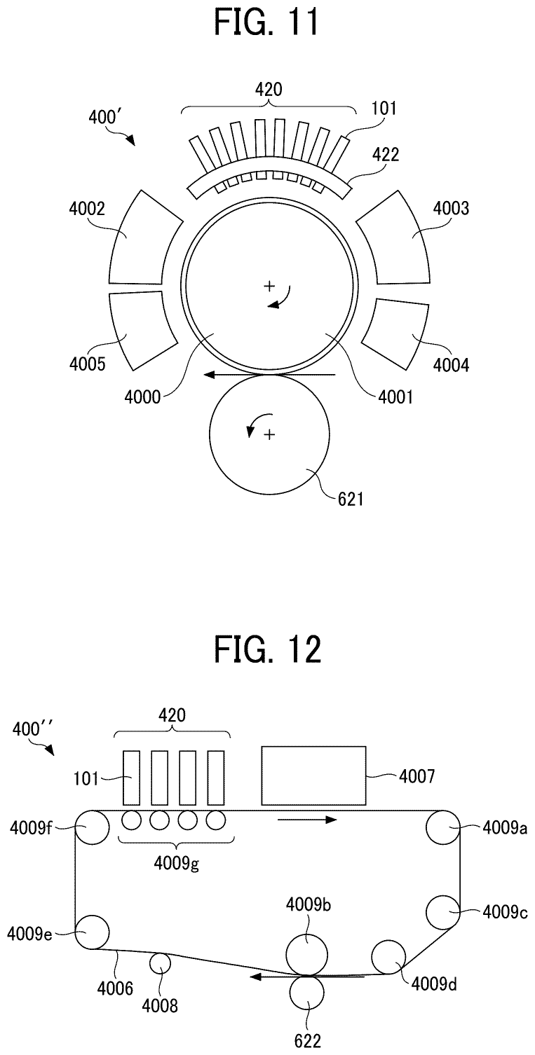

FIG. 11 is a configuration diagram of an example printing unit (first configuration), which employes an inkjet method and a transfer method, as an electrode composite layer-forming liquid composition applying unit in an apparatus for producing an electrode according to an embodiment of the present disclosure. The printing unit in FIG. 11 uses a drum-shaped intermediate transfer body.

A printing unit 400′ is an inkjet printer that transfers the electrode composite layer-forming liquid composition onto the base via an intermediate transfer body 4001, to form an electrode composite layer on the base.

The printing unit 400′ includes an inkjet unit 420, a transfer drum 4000, a preprocessing unit 4002, an absorption unit 4003, a heating unit 4004, and a cleaning unit 4005.

The inkjet unit 420 includes a head module 422 holding a plurality of heads 101.

Each of the heads 101 discharges the electrode composite layer-forming liquid composition onto the intermediate transfer body 4001 supported by the transfer drum 4000, and forms an electrode composite layer-forming liquid composition film on the intermediate transfer body 4001. Each of the heads 101 is a line head, and has nozzles arranged in a range covering the width of a recording area of a base having a maximum usable size. The head 101 includes, on a lower surface thereof, a nozzle surface in which a nozzle is formed, and the nozzle surface faces the front surface of the intermediate transfer body 4001 with a small gap interposed therebetween. In the present embodiment, the intermediate transfer body 4001 is configured to circulate and move on a circular trajectory, and thus, the plurality of heads 101 are arranged radially.

The transfer drum 4000 faces an impression cylinder 621 and forms a transfer nip portion. For example, before the heads 101 discharge the electrode composite layer-forming liquid composition, the preprocessing unit 4002 applies, onto the intermediate transfer body 4001, a reaction liquid to increase the viscosity of the electrode composite layer-forming liquid composition.

The absorption unit 4003 absorbs a liquid component from the electrode composite layer-forming liquid composition present on the intermediate transfer body 4001, before the electrode composite layer-forming liquid composition is transferred.

The heating unit 4004 heats the electrode composite layer-forming liquid composition on the intermediate transfer body 4001, before the electrode composite layer-forming liquid composition is transferred. The heating of the electrode composite layer-forming liquid composition results in formation of an electrode composite layer. The solvent is removed by the heating, and thus the transferability to the base is improved.

The cleaning unit 4005 cleans the intermediate transfer body 4001 after the transfer, to remove foreign substances such as dust and ink remaining on the intermediate transfer body 4001.

The outer circumferential surface of the impression cylinder 621 is in pressure contact with the intermediate transfer body 4001, and when the base passes through the transfer nip portion between the impression cylinder 621 and the intermediate transfer body 4001, the electrode composite layer on the intermediate transfer body 4001 is transferred to the base. Note that the impression cylinder 621 may be configured to include, on the outer circumferential surface thereof, at least one grip mechanism for holding a tip end portion of the base.

FIG. 12 is a configuration diagram of an example printing unit (second configuration), which employes an inkjet method and a transfer method, as an electrode composite layer-forming liquid composition applying unit in an apparatus for producing an electrode according to an embodiment of the present disclosure. The printing unit in FIG. 12 uses an intermediate transfer body in the form of an endless belt.

A printing unit 400″ is an inkjet printer that transfers the electrode composite layer-forming liquid composition on a base via an intermediate transfer belt 4006 to form an electrode composite layer.

The printing unit 400″ includes the inkjet unit 420, a transfer roller 622, the intermediate transfer belt 4006, a heating unit 4007, a cleaning roller 4008, a drive roller 4009a, a counter roller 4009b, a shape-maintaining roller 4009c, a shape-maintaining roller 4009d, a shape-maintaining roller 4009e, and a shape-maintaining roller 4009f.

The printing unit 400″ discharges droplets of the electrode composite layer-forming liquid composition from a plurality of heads 101 provided in the inkjet unit 420 to an outer peripheral surface of the intermediate transfer belt 4006. The electrode composite layer-forming liquid composition on the intermediate transfer belt 4006 is heated by the heating unit 4007 and polymerizes by thermal polymerization to form an electrode composite layer. The electrode composite layer present on the intermediate transfer belt 4006 is transferred to the base in the transfer nip portion where the intermediate transfer belt 4006 faces the transfer roller 622. After transfer, the surface of the intermediate transfer belt 4006 is cleaned by the cleaning roller 4008.

The intermediate transfer belt 4006 is spanned over the drive roller 4009a, the counter roller 4009b, a plurality of shape-maintaining rollers including the shape-maintaining roller 4009c, the shape-maintaining roller 4009d, the shape-maintaining roller 4009e, and the shape-maintaining roller 4009f, and a plurality of support rollers 4009g, and moves in the direction of the arrows in FIG. 12. The support rollers 4009g are provided to face the heads 101 and maintain the intermediate transfer belt 4006 in a tension state when ink droplets are discharged from the heads 101.

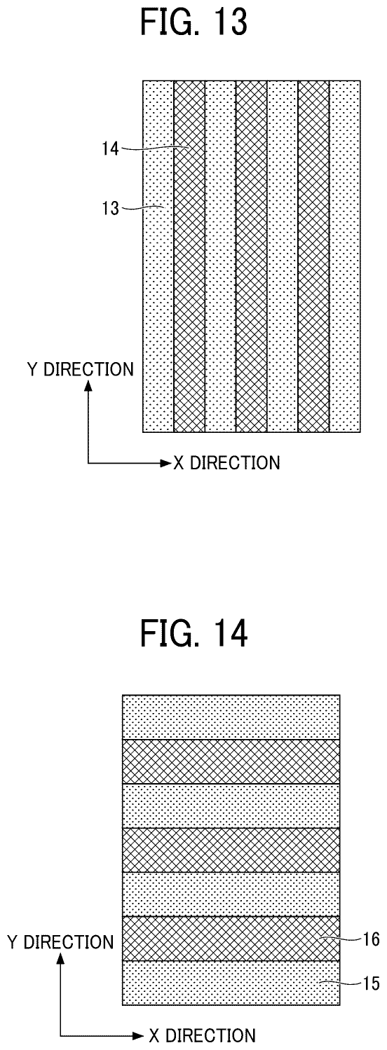

FIG. 13 is a schematic diagram of an example formation pattern of an electrode composite layer in a method for producing an electrode according to an embodiment of the present disclosure. FIGS. 14, 15, 16A, and 16B are schematic diagrams each illustrating another example formation pattern of an electrode composite layer in a method for producing an electrode according to an embodiment of the present disclosure.

In FIGS. 13, 14, 15, 16A, and 16B, the X direction is a direction perpendicular to a printing direction and parallel to the base surface, and the Y direction is the printing direction. Such patterning of the electrode composite layer increases the surface area.

FIG. 13 illustrates an electrode composite layer in which regions 13 (regions A_{High}) with a high binder concentration and regions 14 (regions A_{Low}) with a low binder concentration are periodically formed in the X direction and which is flat in the Y direction.

FIG. 14 illustrates an electrode composite layer in which regions 15 (regions A_{High}) with a high binder concentration and regions 16 (regions A_{Low}) with a low binder concentration are periodically formed in the Y direction and which is flat in the X direction.

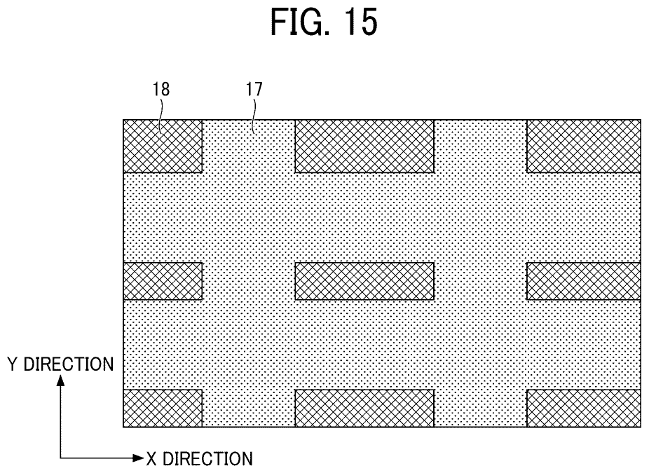

FIG. 15 illustrates an electrode composite layer in which a region 17 (region A_{High}) with a high binder concentration and regions 18 (regions A_{Low}) with a low binder concentration are periodically formed in the X direction, and the region 17 (the region A_{High}) with a high binder concentration and the regions 18 (the regions A_{Low}) with a low binder concentration are periodically formed in the Y direction.

Compared to the configurations illustrated in FIGS. 13 and 14, the lattice structure as illustrated in FIG. 15 in which a region with a high binder concentration (region A_{High}) and a region with a low binder concentration (region A_{Low}) are periodically formed along the X direction and Y direction may exhibit higher performance in terms of prevention of detachment of the active material and thus improve the performance of the electrochemical element.

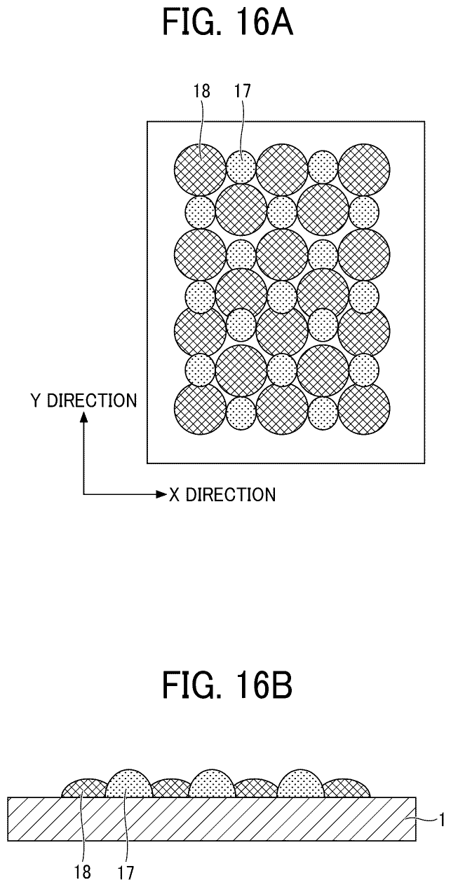

FIGS. 16A and 16B illustrates an electrode composite layer in which the regions 17 (regions A_{High}) with a high binder concentration and the regions 18 (regions A_{Low}) with a low binder concentration are periodically formed in the X direction, and the regions (regions A_{High}) with a high binder concentration and the regions 18 (regions A_{Low}) with a low binder concentration are periodically formed in the Y direction, as illustrated in FIG. 15, and the regions 17 (regions A_{High}) with the high binder concentration and the regions 18 (regions A_{Low}) with the low binder concentration are each dot-shaped (approximately circular).

FIG. 16A is a plan view, and FIG. 16B is a side view. Such a dot pattern can further prevent detachment of the active material, and thus further improve the performance of the electrochemical element.

### (Electrochemical Element)

An electrochemical element of the present disclosure includes the electrode of the present disclosure, and may further include other members, if necessary. In other words, the electrochemical element of the present disclosure may include a positive electrode, a negative electrode, an electrolyte, a separator disposed between the positive electrode and the negative electrode and including an electrolyte, and a casing.

When a solid electrolyte or a gel electrolyte is used, a separator is not necessary.

### <Electrolyte>

The electrolyte may be an aqueous electrolyte solution or a non-aqueous electrolyte liquid.

### —Aqueous Electrolyte Solution—

The aqueous electrolyte solution is an aqueous solution in which an electrolyte salt is dissolved in water.

The electrolyte salt in the aqueous electrolyte solution is not particularly limited and can be appropriately selected according to a purpose. Examples of the electrolyte salt include, but are not limited to, sodium hydroxide, potassium hydroxide, sodium chloride, potassium chloride, ammonium chloride, zinc chloride, zinc acetate, zinc bromide, zinc iodide, zinc tartrate, and zinc perchlorate.

### —Non-Aqueous Electrolyte—

As the non-aqueous electrolyte, a non-aqueous electrolyte liquid, a solid electrolyte, or a gel electrolyte can be used.

### —Non-Aqueous Electrolyte Liquid—

The non-aqueous electrolyte liquid refers to an electrolyte liquid in which an electrolyte salt is dissolved in a non-aqueous solvent.

The non-aqueous solvent is not particularly limited and can be appropriately selected according to a purpose. For example, the non-aqueous solvent is preferably an aprotic organic solvent. Examples of the aprotic organic solvent include, but are not limited to, carbonate-based organic solvents such as chain carbonates and cyclic carbonates. Among these, chain carbonates are preferred because chain carbonates have high ability for dissolving electrolyte salts. Preferably, the aprotic organic solvent has a low viscosity.

Examples of the chain carbonates include, but are not limited to, dimethyl carbonate (DMC), diethyl carbonate (DEC), and methyl ethyl carbonate (EMC).

The content of the chain carbonate in the non-aqueous solvent is preferably 50 mass % or more. When the content of the chain carbonate in the non-aqueous solvent is 50 mass % or more, even when the non-aqueous solvent other than the chain carbonate is a cyclic substance (e.g., cyclic carbonate, cyclic ester) having a high dielectric constant, the content of the cyclic substance is low. Thus, even when the non-aqueous electrolyte liquid has a high concentration of 2M or more, the viscosity of the non-aqueous electrolyte liquid is low, which improves permeation of the non-aqueous electrolyte liquid in the electrode and ion diffusion.

Examples of the cyclic carbonates include, but are not limited to, propylene carbonate (PC), ethylene carbonate (EC), butylene carbonate (BC), and vinylene carbonate (VC).

Examples of the non-aqueous solvent other than the carbonate-based organic solvents include, but are not limited to, ester-based organic solvents such as cyclic esters and chain esters, and ether-based organic solvents such as cyclic ethers and chain ethers.

Examples of the cyclic esters include, but are not limited to, γ-butyrolactone (γ-BL), 2-methyl-γ-butyrolactone, acetyl-γ-butyrolactone, and γ-valerolactone.

Examples of the chain esters include, but are not limited to, propionic acid alkyl esters, malonic acid dialkyl esters, acetic acid alkyl esters (e.g., methyl acetate (MA), ethyl acetate), and formic acid alkyl esters (e.g., methyl formate (MF), ethyl formate).

Examples of the cyclic ethers include, but are not limited to, tetrahydrofuran, alkyltetrahydrofuran, alkoxytetrahydrofuran, dialkoxytetrahydrofuran, 1,3-dioxolane, alkyl-1,3-dioxolane, and 1,4-dioxolane.

Examples of the chain ethers include, but are not limited to, 1,2-dimethoxyethane (DME), diethyl ether, ethylene glycol dialkyl ether, diethylene glycol dialkyl ether, triethylene glycol dialkyl ether, and tetraethylene glycol dialkyl ether.

The electrolyte salt in the non-aqueous electrolyte liquid is not particularly limited as long as the electrolyte salt has high ion conductivity and is soluble in a non-aqueous solvent.

The electrolyte salt in the non-aqueous electrolyte liquid preferably contains a halogen atom.

Examples of cations of the electrolyte salt include, but are not limited to, lithium ion.

Examples of anions of the electrolyte salt include, but are not limited to, BF₄⁻, PF₆⁻, AsF₆⁻, CF₃SO₃⁻, (CF₃SO₂)₂N⁻, and (C₂F₅SO₂)₂N−.

The lithium salt is not particularly limited and can be appropriately selected according to a purpose. Examples of lithium salts include, but are not limited to, lithium hexafluorophosphate (LiPF₆), lithium tetrafluoroborate (LiBF₄), lithium hexafluoroarsenate (LiAsF₆), lithium trifluoromethanesulfonate (LiCF₃SO₃), lithium bis(trifluoromethylsulfonyl)imide (LiN(CF₃SO₂)₂), and lithium bis(pentafluoroethylsulfonyl)imide (LiN(C₂F₅SO₂)₂). Among these, LiPF₆ is preferred from the viewpoint of ion conductivity, and LiBF₄ is preferred from the viewpoint of stability.

The electrolyte salt in the non-aqueous electrolyte liquid may be used alone or in combination of two or more kinds.

The concentration of the electrolyte salt in the non-aqueous electrolyte liquid is not particularly limited and can be appropriately selected according to a purpose. However, for a swing-type non-aqueous electrochemical element, the concentration is preferably from 1 mol/L to 2 mol/L, and for a reserve-type non-aqueous electrochemical element, the concentration is preferably from 2 mol/L to 4 mol/L.

### —Solid Electrolyte—

As the solid electrolyte, those described in the section <<<Solid Electrolyte>>> can be used.

### —Gel Electrolyte—

The gel electrolyte is not particularly limited as long as the gel electrolyte exhibits ion conductivity and can be appropriately selected according to a purpose. Examples of polymers forming a network structure of the gel electrolyte include, but are not limited to, polyethylene oxide, polypropylene oxide, polyacrylonitrile, polymethyl methacrylate, polyvinyl chloride, copolymers of vinylidene fluoride and hexafluoropropylene, and polyethylene carbonate.

The solvent molecules held in the gel electrolyte are not particularly limited and can be appropriately selected according to a purpose. Examples of the solvent molecules include, but are not limited to, an ionic liquid.

Examples of ionic liquids include, but are not limited to, 1-methyl-1-propylpyrrolidinium bis(fluorosulfonylimide), 1-butyl-1-methylpyrrolidinium bis(fluorosulfonylimide), 1-methyl-1-propylpiperidinium bis(fluorosulfonylimide), 1-ethyl-3-methylimidazolium bis(fluorosulfonylimide), 1-methyl-3-propylimidazolium bis(fluorosulfonylimide), and N,N-diethyl-N-methyl-N-(2-methoxyethyl) ammonium bis(fluorosulfonyl)imide.

Alternatively, a mixture of a liquid such as tetraglyme, propylene carbonate, fluoroethylene carbonate, ethylene carbonate, and diethyl carbonate with a lithium salt may be used.

These gel electrolytes may be used alone or in combination of two or more types.

The electrolyte material to be dissolved or dispersed in the liquid to form a gel electrolyte may be a solution in which a polymer compound and an ionic liquid or a lithium salt are dissolved. Furthermore, a material that is a precursor of the gel electrolyte, such as polyethylene oxide or polypropylene oxide having acrylate groups at both ends may be used in combination with a solution in which an ionic liquid or a lithium salt is dissolved.

### <Separator>

A separator is provided between the negative electrode and the positive electrode as necessary, to prevent a short circuit between the negative electrode and the positive electrode.

Examples of the material of the separator include, but are not limited to, paper (e.g., Kraft paper, vinylon mixed paper, synthetic pulp mixed paper), cellophane, polyethylene grafted film, polyolefin unwoven fabric (e.g., polypropylene melt-blown unwoven fabric), polyamide unwoven fabric, glass fiber unwoven fabric, and micropore film.

The size of the separator is not particularly limited as long as the separator can be used for the electrochemical element.

The separator may have either a single-layer structure or a multi-layer structure.

When an aqueous electrolyte solution or a non-aqueous electrolyte liquid is used as the electrolyte, a separator is necessary. However, when a solid electrolyte or a gel electrolyte is used, a separator is not necessary.

### <Casing>

The casing is not particularly limited, as long as the casing can seal the electrodes, the electrolyte, and the separator or the solid electrolyte or the gel electrolyte, and any known casing can be appropriately selected according to a purpose.

The form of the electrochemical element is not particularly limited, and examples of the form include, but are not limited to, a laminate type, a cylinder type in which sheet electrodes and a separator are formed in a spiral shape, a cylinder type having an inside-out structure in which pellet electrodes and a separator are combined, and a coin type in which pellet electrodes and a separator are laminated.

Here, electrochemical elements according to embodiments of the present disclosure will be described with reference to the drawings.

However, the present disclosure is not limited to these embodiments in any way.

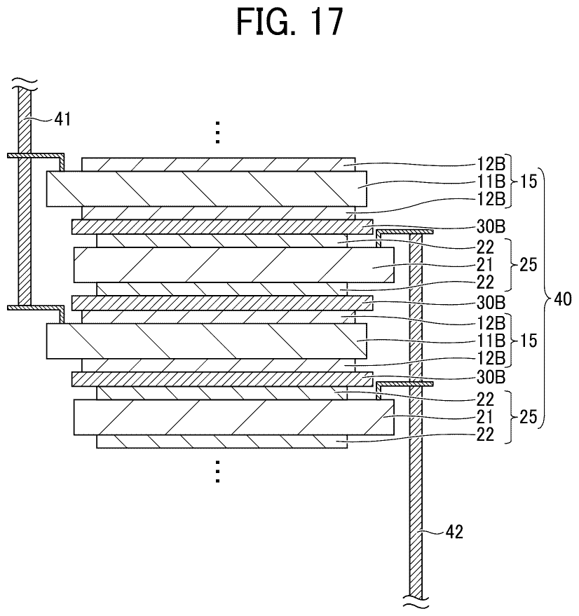

FIG. 17 is a schematic cross-sectional view of an electrochemical element according to an embodiment of the present disclosure.

In an electrode element 40, a negative electrode 15 and a positive electrode 25 are laminated with a separator 30B therebetween. Here, the positive electrode 25 is laminated on both sides of the negative electrode 15. Further, a lead wire 41 is connected to a negative electrode base 11B, and a lead wire 42 is connected to a positive electrode base 21. In the case of a solid electrochemical element, the separator 30B may be replaced with a solid electrolyte or a gel electrolyte.

In the negative electrode 15, a negative electrode composite layer 12B is formed on each of both sides of the negative electrode base 11B.

In the positive electrode 25, a positive electrode composite layer 22 is formed on each of both sides of the positive electrode base 21.

The number of the negative electrodes 15 and the number of the positive electrodes 25 laminated in the electrode element 40 are not particularly limited and can be appropriately selected according to a purpose. The number of the negative electrodes 15 and the number of the positive electrodes 25 in the electrode element 40 may be either the same or different.

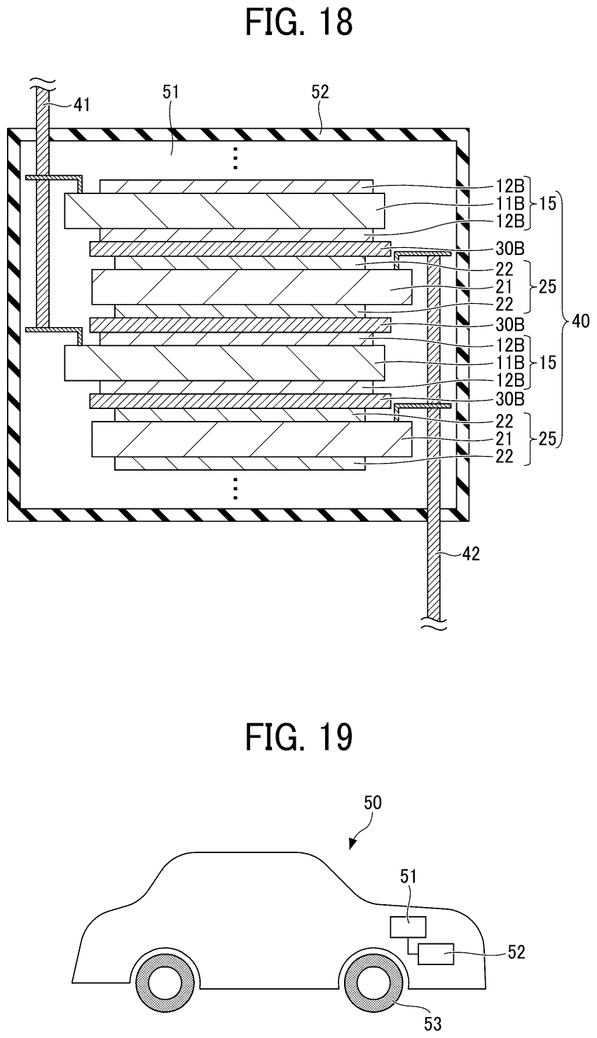

FIG. 18 is a schematic cross-sectional view of an electrochemical element according to an embodiment of the present disclosure.

An electrode element 40 has a configuration similar to that illustrated in FIG. 17. When the electrochemical element is a liquid-based electrochemical element, an electrolyte layer 51 is formed by injecting an aqueous electrolyte solution or a non-aqueous electrolyte into the electrode element 40, and the electrode element 40 is sealed by a casing 52. In the electrochemical element, a lead wire 41 and a lead wire 42 extend out of the casing 52.

When the electrochemical element is a solid electrochemical element, the separator 30B may be replaced with a solid electrolyte or a gel electrolyte.

### (Apparatus for Producing Electrochemical Element and Method for Producing Electrochemical Element)

The apparatus for producing an electrochemical element according to an embodiment of the present disclosure includes an electrode producing device that produces an electrode by the apparatus for producing an electrode of the present disclosure, and an element fabrication device for producing an electrochemical element using the electrode, and further includes another device as necessary.

The method for producing an electrochemical element according to an embodiment of the present disclosure includes an electrode producing step of producing an electrode using the apparatus for producing an electrode of the present disclosure, and an element fabrication step of producing an electrochemical element using the electrode, and further includes another step as necessary.

### <Electrode Producing Device, Electrode Producing Step>

The electrode producing device includes a storage container and an electrode composite layer-forming liquid composition applying unit for applying, onto a base, an electrode composite layer-forming liquid composition contained in the storage container, and further includes another unit as necessary.

The electrode producing step includes an electrode composite layer-forming liquid composition applying step for applying an electrode composite layer-forming liquid composition, and further includes another step as necessary.

The storage container, the electrode composite layer-forming liquid composition applying unit, and the electrode composite layer-forming liquid composition applying step can appropriately include any of features selected from those explained in (Method for Producing Electrode and Apparatus for Producing Electrode).

### <Element Fabrication Device and Element Fabrication Step>

The element fabrication device is a device for producing an electrochemical element using the electrodes.

The element fabrication step is a step of producing an electrochemical element using the electrodes.

The method for producing an electrochemical element by using electrodes is not particularly limited, and any known method for producing an electrochemical element can be appropriately selected according to a purpose. Examples of the method include, but are not limited to, a method of producing an electrochemical element by using at least one process among installation of a counter electrode, winding or lamination, and placement into a container.

Note that the element fabrication step may not include the entire process of element fabrication, and may include a part of the steps of element fabrication, for example, a step of forming an electrode element.

### [Applications of Electrochemical Element]

The electrochemical element can be suitably used as a secondary battery.

The applications of the electrochemical element are not particularly limited and examples thereof include, but are not limited to, notebook computers, pen input computers, mobile computers, e-book players, mobile phones, mobile fax machines, mobile copiers, mobile printers, headphone stereos, video movies, LCD TVs, handy cleaners, portable CDs, mini discs, transceivers, electronic notebooks, electronic calculators, memory cards, mobile tape recorders, radios, backup power supplies, motors, lighting equipment, toys, game equipment, clocks, stroboscopes, cameras, and vehicles.

FIG. 19 is a schematic diagram of a moving body that is an electrochemical element according to an embodiment of the present disclosure.

The moving body 50 is, for example, an electric vehicle. The moving body 50 includes a motor 51, an electrochemical element 52, and wheels 53.

The electrochemical element 52 is the electrochemical element of the present disclosure. The electrochemical element 52 supplies power to the motor 51 to drive the motor 51. The motor 51 that is being driven can drive the wheels 53, and as a result, the moving body 50 can move.

The moving body 50 including the electrochemical element 52 can move safely and efficiently, because the moving body 50 is driven by electric power from the electrochemical element in which a short circuit between the positive electrode and the negative electrode is prevented and which has excellent battery characteristics.

The moving body 50 is not limited to the electric vehicle, but may be a PHEV, an HEV, or a locomotive and a motorcycle that can travel by using a combination of a diesel engine and an electrochemical element. Further, the moving body 50 may be a transport robot used in a factory or the like, and may travel by using an electrochemical element or a combination of an engine and an electrochemical element. The moving body 50 may be an object in which the object as a whole does not move, but a part of the object moves, such as an assembly robot that is placed on a production line in a factory and can operate an arm or the like by using an electrochemical element or a combination of an engine and an electrochemical element.

### EXAMPLES

The present disclosure will be described in more detail below with reference to Examples and Comparative Examples, but the present disclosure is not limited to these Examples in any way. In the following Examples and Comparative Examples, unless otherwise specified, “parts” means “parts by mass” and “%” means “mass %”.

### Example 1

### <Preparation of Negative Electrode Composite Layer-Forming Liquid Composition>

A negative electrode composite layer-forming liquid composition (electrode composite layer-forming liquid composition) was prepared by mixing and dispersing solid components (an active material, binder, conductive auxiliary agent, and dispersant) in a dispersion medium by using a rotation-revolution type mixer (MAZERUSTAR, manufactured by KURABO INDUSTRIES, LTD.). The composition of the negative electrode composite layer-forming liquid composition or addition amounts of the components are presented in Table 1.

The details of each component are as follows:
Gr: Artificial graphite (manufactured by ALDRICH, D50=5 μm)
SiO: Silicon oxide (manufactured by ALDRICH, D50=8 μm)
SBR: Styrene-butadiene-rubber (manufactured by ALDRICH)
AB: Acetylene black (DENKA BLACK, manufactured by DENKA COMPANY LIMITED)
CMC: Sodium carboxymethylcellulose (manufactured by ALDRICH)

### <Preparation of Negative Electrode>

A valve-type nozzle disclosed in Japanese Patent No. 7271956 was attached to an inkjet discharge evaluation device (device name: EV2500, manufactured by RICOH COMPANY, LTD.), and the negative electrode composite layer-forming liquid composition was applied onto a copper foil current collector having an average thickness of 15 μm. The nozzle interval (period T) was 2.54 mm. At the timing when adjacent droplets merged with each other due to leveling in the applied electrode composite layer-forming liquid composition and haze in the liquid surface was no longer visible to the naked eye, the composition was heated and dried at 80° C. to obtain a negative electrode.

### Examples 2 to 17

As presented in Tables 1 to 4, negative electrode composite layer-forming liquid compositions and negative electrodes were prepared in the same manner as in Example 1, except that different compositions of the negative electrode composite layer-forming liquid compositions, and/or different periods T were used, and for some of these Examples, pressing was conducted.

The details of each component are as follows:
Urethane binder (manufactured by SANYO CHEMICAL INDUSTRIES, LTD.)

### Example 18

A positive electrode composite layer-forming liquid composition (electrode composite layer-forming liquid composition) was prepared by mixing and dispersing solid components (an active material, binder, conductive auxiliary agent, and dispersant) in a dispersion medium by using a rotation-revolution type mixer (MAZERUSTAR, manufactured by KURABO INDUSTRIES, LTD.). The composition of the positive electrode composite layer-forming liquid composition or addition amounts of the components are presented in Tables 1 to 4.

The details of each component are as follows:
NCM: Lithium nickel cobalt manganese oxide (average primary particle diameter: 3.5 μm, manufactured by TOSHIMA MANUFACTURING CO., LTD.)
P(DEAmEMA-BMA): Poly(diethylaminoethyl methacrylate-butyl methacrylate) copolymer
PBMA: Polybutyl methacrylate (manufactured by ALDRICH)
BYK-ET3000 (manufactured by BYK)
NMP: N-methyl-2-pyrrolidone (manufactured by TOKYO CHEMICAL INDUSTRY CO., LTD.)

P (DEAmEMA-BMA): poly(diethylaminoethyl methacrylate-butyl methacrylate) copolymer was synthesized as follows.

Under a nitrogen stream, degassed toluene was added to a flask and heated to 80° C., and a mixed solution of 33 mL of toluene, 25.00 g (175.8 mmol) of butyl methacrylate, 8.14 g (43.95 mmol) of 2-(diethylamino)ethyl methacrylate, and 109 mg (0.440 mmol) of 2,2′-azobis(2,4-dimethylvaleronitrile) was added dropwise to the flask over 1 hour with stirring. After completion of the addition, the mixture was stirred at 80° C. for 8 hours and allowed to cool to room temperature. The reaction solution was then added dropwise to methanol, and the precipitate was separated by decantation and dried in vacuum to obtain the synthesized product.

### <Preparation of Positive Electrode>

A valve-type nozzle disclosed in Japanese Patent No. 7271956 was attached to an inkjet discharge evaluation device (device name: EV2500, manufactured by RICOH COMPANY, LTD.), and the positive electrode composite layer-forming liquid composition was applied onto an aluminum foil current collector having an average thickness of 15 μm. The nozzle interval (period T) was 2.54 mm. At the timing when adjacent droplets merged with each other due to leveling in the applied positive electrode composite layer-forming liquid composition and haze in the liquid surface was no longer visible to the naked eye, the composition was heated and dried at 80° C. to obtain a positive electrode.

### Examples 19 to 28

As presented in Tables 1 to 4, positive electrode composite layer-forming liquid compositions and positive electrodes were prepared in the same manner as in Example 18, except that different compositions of the positive electrode composite layer-forming liquid compositions, and/or different periods T were used.

### Example 29

A positive electrode composite layer-forming liquid composition (electrode composite layer-forming liquid composition) was prepared by mixing and dispersing solid components (an active material, binder, conductive auxiliary agent, and dispersant) in a dispersion medium by using a rotation-revolution type mixer (MAZERUSTAR, manufactured by KURABO INDUSTRIES, LTD.). The composition of the positive electrode composite layer-forming liquid composition or addition amounts of the components are presented in Tables 1 to 4.

The details of each component are as follows:
LiNbO₃/NCM: Lithium nickel cobalt manganese oxide coated with lithium niobate
Butyl butyrate: TOKYO CHEMICAL INDUSTRY CO., LTD.
LPSC: Argyrodite-type sulfide solid electrolyte Li₆PS₅Cl

### [Surface Coating of Active Material Using Ion-Conductive Oxide]

The active material is a nickel-based positive electrode active material (lithium nickel cobalt manganese oxide, hereinafter may be referred to as “NCM”, average primary particle diameter: 3.5 μm, manufactured by TOSHIMA MANUFACTURING CO., LTD.) was used. LiNbO₃ was used as the ion-conductive oxide for coating the surfaces of NCM particles.

An alkoxide solution containing lithium and niobium was hydrolyzed on the surfaces of the NCM powder particles to form a LiNbO₃ layer, according to a publicly known literature “J. Mater. Chem. A. 2021, 9, 4117-4125”. First, metallic lithium (manufactured by HONJO METAL CO., LTD.) was dissolved in anhydrous ethanol (manufactured by KANTO CHEMICAL CO., INC.) to prepare an ethanol solution of lithium ethoxide. Further, niobium pentaethoxide (Nb(OC₂H₅)₅) (manufactured by KOJUNDO CHEMICAL LABORATORY CO., LTD.) was added to the solution to obtain an alkoxide solution containing lithium and niobium. A tumbling fluidizer device (MP-01, manufactured by POWREX CORP.) was used to obtain a fluidized bed of the NCM powder and the above-mentioned alkoxide solution was sprayed onto the powder to obtain a precursor powder in which the surface of the NCM powder particles was coated with the alkoxide. By heating the powder at 350° C. in a dry air atmosphere, LiNbO₃ layers were formed on the surfaces of the NCM particles (hereinafter sometimes referred to as “LNO/NCM”).

### [Synthesis of Argyrodite-Type Sulfide Solid Electrolyte]

An argyrodite-type sulfide solid electrolyte Li₆PS₅Cl (LPSC) synthesized according to a publicly known literature 1 “J. Power Sources. 2018, 396, 33-40” was used. Specific synthesis procedure is as follows.

0.5 g of Li₂S (99.9%, manufactured by MITSUWA CHEMICAL CO., LTD.), 0.5 g of P₂S₅ (99%, manufactured by SIGMA-ALDRICH), and 0.5 g of LiCl (99%, manufactured by SIGMA-ALDRICH) were pulverized for 40 hours using a planetary ball mill (manufactured by PULVERISETTE, FRITSCH, Germany) to obtain a sulfide solid electrolyte. The pulverization was carried out at 600 RPM in a zirconia pot (45 mL) using 15 zirconia balls (diameter: 10 mm).

### <Preparation of Positive Electrode>

A valve-type nozzle disclosed in Japanese Patent No. 7271956 was attached to an inkjet discharge evaluation device (device name: EV2500, manufactured by RICOH COMPANY, LTD.), and the positive electrode composite layer-forming liquid composition was applied onto an aluminum foil current collector having an average thickness of 15 μm. The nozzle interval (period T) was 1.27 mm. At the timing when adjacent droplets merged with each other due to leveling in the applied positive electrode composite layer-forming liquid composition and haze in the liquid surface was no longer visible to the naked eye, the composition was heated and dried at 80° C. to obtain a positive electrode.

### Examples 30 to 34

As presented in Tables 1 to 4, positive electrode composite layer-forming liquid compositions and positive electrodes were prepared in the same manner as in Example 29, except that different compositions of the positive electrode composite layer-forming liquid compositions, and/or different periods T were used.

### Comparative Example 1

The negative electrode composite layer-forming liquid composition prepared in Example 1 was applied onto a copper foil current collector having an average thickness of 15 μm using a die coater (AUTO FILM APPLICATOR, manufactured by TESTER SANGYO CO, LTD.), and then heated and dried at 80° C. to obtain a negative electrode.

### Comparative Example 2

As presented in Tables 1 to 4, different compositions of the negative electrode composite layer-forming liquid composition were used to prepare a negative electrode composite layer-forming liquid composition of Comparative Example 2-1 and a negative electrode composite layer-forming liquid composition of Comparative Example 2-2.

A copper foil having an average thickness of 10 μm and a paraffin film having an average thickness of 30 μm (manufactured by PLASTIC PACKAGING) were provided, and holes (1.25 mm×20 mm) were formed at 2.50 mm intervals in the paraffin film. The paraffin film was bonded onto the copper foil, and the negative electrode composite layer-forming liquid composition of Comparative Example 2-1 was applied using a doctor blade to fill the holes formed in the paraffin film. The resulting sheet was dried at 80° C. for 1 minute. The paraffin film was removed from the obtained sheet, and as a result, a first electrode composite layer having a diameter of 11 mm was formed on the copper foil. The negative electrode composite layer-forming liquid composition of Comparative Example 2-2 was applied using a doctor blade to cover the base and the first electrode composite layer, thereby forming a second electrode composite layer. The resulting sheet was dried at 80° C. for 20 minutes, and then the base and the electrode composite layer were firmly bonded together using a roll press. Next, the copper foil on which the first electrode composite layer and the second electrode composite layer were formed was subjected to punching with a circular punch having a diameter of 16 mm. The punched copper foil on which the first electrode composite layer and the second electrode composite layer were formed were heated in a vacuum dryer at 120° C. for 3 hours. In this way, the electrode including the first electrode composite layer and the second electrode composite layer was produced.

### Comparative Example 3

As presented in Tables 1 to 4, a negative electrode composite layer-forming liquid composition and a negative electrode were prepared in the same manner as in Comparative Example 1, except that a different composition of the negative electrode composite layer-forming liquid composition was used.

### Comparative Example 4

A negative electrode composite layer-forming liquid composition and a negative electrode were prepared in the same manner as in Comparative Example 3, except that the drying temperature of the negative electrode composite layer-forming liquid composition was changed to 25° C.

### Comparative Example 5

The positive electrode composite layer-forming liquid composition prepared in Example 18 was applied onto an aluminum foil current collector having an average thickness of 15 μm using a die coater (AUTO FILM APPLICATOR, manufactured by TESTER SANGYO CO, LTD.), and then heated and dried at 80° C. to obtain a negative electrode.

### Comparative Example 6

As presented in Tables 1 to 4, different compositions of the positive electrode composite layer-forming liquid composition were used to prepare a positive electrode composite layer-forming liquid composition of Comparative Example 6-1 and a positive electrode composite layer-forming liquid composition of Comparative Example 6-2.

A copper foil having an average thickness of 10 μm and a paraffin film having an average thickness of 30 μm (manufactured by PLASTIC PACKAGING) were provided, and holes (1.25 mm×20 mm) were formed at 2.50 mm intervals in the paraffin film. The paraffin film was bonded onto the copper foil, and the negative electrode composite layer-forming liquid composition of Comparative Example 6-1 was applied using a doctor blade to fill the holes formed in the paraffin film. The resulting sheet was dried at 80° C. for 1 minute. The paraffin film was removed from the obtained sheet, and as a result, a first electrode composite layer having a diameter of 11 mm was formed on the copper foil. The negative electrode composite layer-forming liquid composition of Comparative Example 6-2 was applied using a doctor blade to cover the base and the first electrode composite layer, thereby forming a second electrode composite layer. The resulting sheet was dried at 80° C. for 20 minutes, and then the base and the electrode composite layer were firmly bonded together using a roll press. Next, the copper foil on which the first electrode composite layer and the second electrode composite layer were formed was subjected to punching with a circular punch having a diameter of 16 mm. The punched copper foil on which the first electrode composite layer and the second electrode composite layer were formed were heated in a vacuum dryer at 120° C. for 3 hours. In this way, the electrode including the first electrode composite layer and the second electrode composite layer was produced.

### Comparative Example 7

With reference to Japanese Unexamined Patent Application Publication No. 2023-138315, an industrial inkjet head (MH5420, manufactured by RICOH COMPANY, LTD.) was attached to an inkjet discharge evaluation device (device name: EV2500, manufactured by RICOH COMPANY, LTD.), and the positive electrode composite layer-forming liquid composition was applied onto an aluminum foil current collector having an average thickness of 15 μm. Using the electrode composite layer-forming liquid composition, a positive electrode composite layer having a plurality of convex portions was formed on a current collector, such that the distance between the apexes of a convex portion and a non-convex portion adjacent to each other was 125 μm, and h3 (h2−h1) obtained by subtracting the height h1 of the non-convex portion from the height h2 of the convex portion was 8 μm. Then, the positive electrode composite layer was dried by heating at 120° C. on a hot plate. This procedure was repeated 10 times to achieve a basis weight of 20 mg/cm², and the sample was subjected to pressing with a 7-tons hydraulic roll press (manufactured by THANK-METAL CO., LTD.). As a result, a positive electrode was obtained.

For the electrode obtained in each of Examples and Comparative Examples, a measurement method of a thixotropy index, measurement of continuity and period, evaluation of an average thickness, evaluation of an average porosity, evaluation of a binder concentration in a film thickness direction, evaluation of rate characteristics, and evaluation of cycle characteristics were performed. The results are presented in Tables 5 to 8.

### [Measurement of Thixotropy Index]

The viscosity of the resulting liquid composition was measured at 100 rpm and 10 rpm at room temperature (25° C.) using a TV25 viscometer (cone-plate type viscometer, manufactured by TOKI SANGYO CO., LTD.). The thixotropy index (TI) was calculated by dividing the viscosity at 10 rpm by the viscosity at 100 rpm. The results are presented in Tables 5 to 8.

### [Continuity and Periodicity Measurement]

### —Method A: Case of Binder Containing Characteristic Element—

Type 53 epoxy resin for embedding (Lot No. 53512040149, SANKEI CO., LTD.) as a base material and a curing agent (Lot No. 53572040342, SANKEI CO., LTD.) were thoroughly mixed (volume ratio: 1:2), and an electrode composite layer was embedded in the resin using a vacuum impregnation device (BUEHLER VACUUM IMPREGNATION EQUIPMENT I, SANKEI CO., LTD.) and allowed to harden for 24 hours. The electrode composite layer embedded in the epoxy resin was processed with CROSS SECTION POLISHER (manufactured by JEOL LTD.), a cross section of the electrode composite layer was observed with a desktop scanning electron microscope SEM/EDX (PHENOM PROX, manufactured by JASCO INTERNATIONAL CO., LTD.), and element mapping on the cross section is conducted. The period was calculated based on the binder concentration distribution in the X direction or the Y direction and the continuity was confirmed. If the binder did not contain any characteristic element, but the binder could be stained by using electron staining with osmium tetroxide or ruthenium tetroxide, element mapping was conducted by using this method.

### —Method B: Case of Binder Not Containing Characteristic Element—

The electrode composite layer was cut using a surface and interfacial cutting analysis system (SAICAS) at intervals that are 1/10 of the period intended for the production method. The collected samples were subjected to pyrolysis GC/MS analysis to obtain peak values for fragments from the binder. These peak values were applied to a calibration curve obtained using known binder concentrations to quantify the binder concentration. The period was calculated by plotting the binder concentration in each sample.

### [Evaluation of Average Thickness]

### —Method A: Case of Binder Containing Characteristic Element—

In the method A of [Continuity and Periodicity Measurement], the binder concentration in the entire cross section was used as the average binder concentration C_{AVE}. The binder concentration in the X direction or Y direction was averaged in the thickness (Z) direction, and the cross section was divided into regions A_{High} with a binder concentration higher than the average binder concentration C_{AVE}, and regions A_{Low} with a binder concentration lower than the average binder concentration C_{AVE}. The average thickness t_{High} in the region A_{High} and the average thickness t_{Low} in the region A_{Low} were measured and compared.

### —Method B: Case of Binder Not Containing Characteristic Element—

In the method B of [Continuity and Periodicity Measurement], the cutting depths by SAICAS upon reaching the base (film thickness) were acquired and associated with the calculated period, to calculate and compare the average thickness t_{High} of the region A_{High} and the average thickness t_{Low} of the region A_{Low}.

### [Evaluation of Average Porosity]

### —Method A: Case of Binder Containing Characteristic Element—

In the method A of [Continuity and Periodicity Measurement], the SEM image of the obtained electrode composite layer was binarized using image processing software (IMAGE-PRO PREMIER version 9.2 64-bit, HAKUTO CO., LTD.), and the area of regions associated with particles and the area of regions associated with voids were calculated for each of the region A_{High} and the region A_{Low}, to measure and compare the porosity φ_{High} of the region A_{High} and the porosity φ_{Low} of the region A_{Low}. Whether the cutting has reached the base can be easily determined based on the stress profile during cutting.

### —Method B: Case of Binder Not Containing Characteristic Element—

Using the average thickness and cutting width obtained in the method B of [Continuity and Periodicity Measurement], the porosity φ_{High} of the region A_{High} and the porosity φ_{Low} of the region A_{Low} were calculated and compared.

### [Evaluation of Binder Concentration in Film Thickness Direction]

### —Method A: Case of Binder Containing Characteristic Element—

In the method A of [Continuity and Periodicity Measurement], divisions A_{High}, surface and A_{High}, Under were defined by equally dividing, in two, the distance from the base to the average thickness t_{High} of the region A_{High}. The average binder concentration C_{High, surface} of A_{High, surface} and the average binder concentration C_{High, Under} Of A_{High, Under} were measured and compared.

### —Method B: Case of Binder Not Containing Characteristic Element—

Cutting was performed using distances obtained by equally dividing, in two, the distance from the average thickness obtained in the method B of [Continuity and Periodicity Measurement] to the base, and quantitative evaluation was performed by using pyrolysis GC/MS to calculate and compare the average binder concentration C_{High, surface} Of A_{High, surface} and the average binder concentration C_{High, Under} Of A_{High, Under}.

### [Evaluation of Rate Characteristics]

The rate characteristics of each positive electrode or each negative electrode were evaluated using a charge-discharge test system (TOSCAT3001, manufactured by TOYO SYSTEM CO., LTD.).

The prepared positive electrode was formed in a circular shape with a diameter of 16 mm by punching, and then an electrochemical element was prepared by placing, in a coin can, the positive electrode or negative electrode, a 100 μm thick glass separator D (manufactured by ADVANTEC), an electrolyte (1.5 mol/L LiPF₆/(ethylene carbonate (EC):dimethyl carbonate (DMC):ethyl methyl carbonate (EMC) (1:1:1 v/v %)+fluoroethylene (FEC) 10%) (manufactured by KISHIDA CHEMICAL CO., LTD.)), and a 200 μm thick lithium foil (manufactured by HONJO METALS CO., LTD.) as a counter electrode.

For evaluation of a positive electrode, the prepared electrochemical element was charged at a constant current at C rates of 0.2 C, 1.0 C, 2.0 C, 3.0 C, 4.0 C, and 5.0 C at room temperature (25° C.) until the voltage increased to 4.2 V, and then discharged at a constant current until the voltage decreased to 3.0 V, to measure the charge/discharge capacity. Furthermore, a capacity retention rate defined as the ratio of the discharge capacity at 0.2 C and the discharge capacity at 5.0 C was calculated for evaluation of the rate characteristics.

For evaluation of a negative electrode, the rate characteristics were evaluated under the same conditions as for the positive electrode, except that the electrochemical element was charged at a constant current until the voltage increased to 2.0 V and discharged at a constant current until the voltage decreased to 0.05 V.

In evaluation of a positive electrode for an all-solid-state battery, a 100 μm-thick solid electrolyte was used instead of a glass separator and an electrolyte, and a 200 μm-thick indium (manufactured by HONJO METALS CO., LTD.) and a 200 μm-thick lithium (manufactured by HONJO METALS CO., LTD.) were used instead of lithium foil as a counter electrode. The applied voltage range was from 2.4V to 3.7V.

As a comparative electrode used in evaluation of rate characteristics, an electrode not having a periodic binder concentration distribution was prepared by applying an electrode composite layer-forming liquid composition having the same composition to a current collector foil with an applicator and drying the applied composition. The rate characteristics was evaluated as a relative value to the capacity retention rate of the comparative flat electrode being 100. The passing grade is “C-minus” or better.

### <Evaluation Criteria>

A: (Capacity retention rate of electrode of interest/Capacity retention rate of comparative electrode×100) is 115 or more and less than 120
B: (Capacity retention rate of electrode of interest/Capacity retention rate of comparative electrode×100) is 110 or more and less than 115
C: (Capacity retention rate of electrode of interest/Capacity retention rate of comparative electrode×100) is 105 or more and less than 110
C-minus: (Capacity retention rate of electrode of interest/Capacity retention rate of comparative electrode×100) is 100 or more and less than 105
D: (Capacity retention rate of electrode of interest/Capacity retention rate of comparative electrode×100) is less than 100

### [Evaluation of Cycle Characteristics]

The capacity retention rate of each positive electrode or each negative electrode were evaluated using a charge-discharge test system (TOSCAT3001, manufactured by TOYO SYSTEM CO., LTD.).

The prepared positive electrode was formed in a circular shape with a diameter of 16 mm by punching, and then an electrochemical element was prepared by placing, in a coin can, the positive electrode or negative electrode, a 100 μm thick glass separator D (manufactured by ADVANTEC), an electrolyte (1.5 mol/L LiPF₆/(ethylene carbonate (EC):dimethyl carbonate (DMC):ethyl methyl carbonate (EMC) (1:1:1 v/v %)+fluoroethylene (FEC) 10%) (manufactured by KISHIDA CHEMICAL CO., LTD.)), and a 200 μm thick lithium foil (manufactured by HONJO METALS CO., LTD.) as a counter electrode.

For evaluation of a positive electrode, a cycle charge-discharge test was conducted by charging the prepared electrochemical element at a constant current of 2.0 C at room temperature (25° C.) until the voltage increased to 4.2 V, and then discharging the electrochemical element at a constant current until the voltage decreased to 3.0 V. In the first cycle, under conditions where the electrochemical element was charged at a constant current of 0.2 C until the voltage increased to 4.2 V and then discharged at a constant current until the voltage decreased to 3.0 V, the discharge capacity was measured as an initial discharge capacity A per unit area of the positive electrode. Furthermore, after 500 charge/discharge cycles, under conditions where the electrochemical element was charged at a constant current of 0.2 C until the voltage increased to 4.2 V and then discharged at a constant current until the voltage decreased to 3.0 V, the discharge capacity at the 500th cycle was measured as a discharge capacity B per unit area of the positive electrode. The capacity retention rate of the positive electrode was calculated according to Equation (5).

Capacity retention rate (%)=(discharge capacity B/discharge capacity A)×100 Equation (5)

For evaluation of a negative electrode, a cycle charge-discharge test was conducted by charging the prepared electrochemical element at a constant current of 2.0 C at room temperature (25° C.) until the voltage increased to 2.0 V, and then discharging the electrochemical element at a constant current until the voltage decreased to 0.05 V. In the first cycle, under conditions where the electrochemical element was charged at a constant current of 0.2 C until the voltage increased to 2.0 V and then discharged at a constant current until the voltage decreased to 0.05 V, the discharge capacity was measured as an initial discharge capacity A per unit area of the negative electrode. Furthermore, after 500 charge/discharge cycles, under conditions where the electrochemical element was charged at a constant current of 0.2 C until the voltage increased to 2.0 V and then discharged at a constant current until the voltage decreased to 0.05 V, the discharge capacity at the 500th cycle was measured as a discharge capacity B per unit area of the negative electrode. The capacity retention rate of the negative electrode was calculated according to Equation (6).

Capacity retention rate (%)=(discharge capacity B/discharge capacity A)×100 Expression (6)

In evaluation of a positive electrode for an all-solid-state battery, a 100 μm-thick solid electrolyte was used instead of a glass separator and an electrolyte, and a 200 μm-thick indium (manufactured by HONJO METALS CO., LTD.) and a 200 μm-thick lithium (manufactured by HONJO METALS CO., LTD.) were used instead of lithium foil as a counter electrode. The applied voltage range was from 2.4V to 3.7V.

As a comparative electrode used in evaluation of cycle characteristics, an electrode not having a periodic binder concentration distribution was prepared by applying an electrode composite layer-forming liquid composition having the same composition to a current collector foil with an applicator and drying the applied composition. The cycle characteristics was evaluated as a relative value to the capacity retention rate of the comparative flat electrode being 100. The passing grade is “C-minus” or better.

### <Evaluation Criteria>

A: (Capacity retention rate of electrode of interest/Capacity retention rate of comparative electrode×100) is 115 or more and less than 120
B: (Capacity retention rate of electrode of interest/Capacity retention rate of comparative electrode×100) is 110 or more and less than 115
C: (Capacity retention rate of electrode of interest/Capacity retention rate of comparative electrode×100) is 105 or more and less than 110
C-minus: (Capacity retention rate of electrode of interest/Capacity retention rate of comparative electrode×100) is 100 or more and less than 105
D: (Capacity retention rate of electrode of interest/Capacity retention rate of comparative electrode×100) is less than 100

TABLE 1

| | | | Electrode composite layer-forming liquid composition | | | | | | | | |
|---|---|---|---|---|---|---|---|---|---|---|---|
| | | | | | | | | Other components | | | |
| | | | | | | | | Conductive | | | |
| | | | Active material | | Binder | | | auxiliary agent | | Dispersant | |
| | Electrode | | | Mass | | Mass | Dissolution/ | | Mass | | Mass |
| Ex. | type | Base | Material | ratio | Material | ratio | dispersion | Material | ratio | Material | ratio |
| Ex. 1 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 2 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 3 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 4 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 5 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 6 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 7 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 8 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 9 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 10 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 11 | Liquid LIB | Copper foil | Gr:SiO | 80:20:00 | Urethane- | 5 | Soluble | AB | 1 | CMC | 1 |
| | negative | | | | based | | | | | | |
| | electrode | | | | binder | | | | | | |

| | Electrode composite layer-forming liquid composition | | | | | | | | |
|---|---|---|---|---|---|---|---|---|---|
| | Other components | | | | | | | | |
| | Solid Electrolyte | | Dispersion medium | | Solid | Viscosity at | | | |
| | | Mass | | Mass | content | 100 rpm | Thixotropy | Applying | Pressing |
| Ex. | Material | ratio | Material | ratio | [wt %] | [cp] | index | method | process |
| Ex. 1 | — | — | Water | 198.7 | 35 | 20 | 1.2 | Inkjet printing | No |
| Ex. 2 | — | — | Water | 198.7 | 35 | 20 | 1.2 | Inkjet printing | No |
| Ex. 3 | — | — | Water | 198.7 | 35 | 20 | 1.2 | Inkjet printing | No |
| Ex. 4 | — | — | Water | 198.7 | 35 | 20 | 1.2 | Inkjet printing | No |
| Ex. 5 | — | — | Water | 198.7 | 35 | 20 | 1.2 | Inkjet printing | No |
| Ex. 6 | — | — | Water | 198.7 | 35 | 20 | 1.2 | Inkjet printing | No |
| Ex. 7 | — | — | Water | 198.7 | 35 | 20 | 1.2 | Inkjet printing | No |
| Ex. 8 | — | — | Water | 160.5 | 40 | 40 | 1.5 | Inkjet printing | No |
| Ex. 9 | — | — | Water | 160.5 | 40 | 40 | 1.5 | Inkjet printing | Yes |
| Ex. 10 | — | — | Water | 130.8 | 45 | 60 | 2 | Inkjet printing | Yes |
| Ex. 11 | — | — | Water | 160.5 | 40 | 40 | 1.5 | Inkjet printing | No |

TABLE 2

| | | | Electrode composite layer-forming liquid composition | | | | | | | | |
|---|---|---|---|---|---|---|---|---|---|---|---|
| | | | | | | | | Other components | | | |
| | | | | | | | | Conductive | | | |
| | | | Active material | | Binder | | | auxiliary agent | | Dispersant | |
| | Electrode | | | Mass | | Mass | Dissolution/ | | Mass | | Mass |
| Ex. | type | Base | Material | ratio | Material | ratio | dispersion | Material | ratio | Material | ratio |
| Ex. 12 | Liquid LIB | Copper foil | Gr:SiO | 80:20:00 | Urethane- | 5 | Soluble | AB | 1 | CMC | 1 |
| | negative | | | | based | | | | | | |
| | electrode | | | | binder | | | | | | |
| Ex. 13 | Liquid LIB | Copper foil | Gr:SiO | 80:20:00 | Urethane- | 5 | Soluble | AB | 1 | CMC | 1 |
| | negative | | | | based | | | | | | |
| | electrode | | | | binder | | | | | | |
| Ex. 14 | Liquid LIB | Copper foil | Gr:SiO | 80:20:00 | Urethane- | 5 | Soluble | AB | 1 | CMC | 1 |
| | negative | | | | based | | | | | | |
| | electrode | | | | binder | | | | | | |
| Ex. 15 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 16 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| Ex. 17 | Liquid LIB | Copper foil | SiO | 100 | Urethane- | 5 | Soluble | SWCNT | 0.1 | CMC | 1 |
| | negative | | | | based | | | | | | |
| | electrode | | | | binder | | | | | | |
| Ex. 18 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 19 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 20 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 21 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 22 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |

| | Electrode composite layer-forming liquid composition | | | | | | | | |
|---|---|---|---|---|---|---|---|---|---|
| | Other components | | | | | | | | |
| | Solid Electrolyte | | Dispersion medium | | Solid | Viscosity at | | | |
| | | Mass | | Mass | content | 100 rpm | Thixotropy | Applying | Pressing |
| Ex. | Material | ratio | Material | ratio | [wt %] | [cp] | index | method | process |
| Ex. 12 | — | — | Water | 130.8 | 45 | 50 | 2 | Inkjet printing | Yes |
| Ex. 13 | — | — | Water | 130.8 | 45 | 50 | 2 | Inkjet printing | Yes |
| Ex. 14 | — | — | Water | 107 | 50 | 70 | 2.5 | Inkjet printing | Yes |
| Ex. 15 | — | — | Water | 198.7 | 35 | 20 | 1.2 | Inkjet printing | No |
| Ex. 16 | — | — | Water | 198.7 | 35 | 20 | 1.2 | Inkjet printing | No |
| Ex. 17 | — | — | Water | 157.6 | 40 | 70 | 3 | Inkjet printing | No |
| Ex. 18 | — | — | NMP | 69.8 | 60 | 20 | 1.5 | Inkjet printing | Yes |
| Ex. 19 | — | — | NMP | 69.8 | 60 | 20 | 1.5 | Inkjet printing | Yes |
| Ex. 20 | — | — | NMP | 69.8 | 60 | 20 | 1.5 | Inkjet printing | Yes |
| Ex. 21 | — | — | NMP | 69.8 | 60 | 20 | 1.5 | Inkjet printing | Yes |
| Ex. 22 | — | — | NMP | 69.8 | 60 | 20 | 1.5 | Inkjet printing | Yes |

[symbol]

indicates data missing or illegible when filed

TABLE 3

| | | | Electrode composite layer-forming liquid composition | | | | | | | | |
|---|---|---|---|---|---|---|---|---|---|---|---|
| | | | | | | | | Other components | | | |
| | | | | | | | | Conductive | | | |
| | | | Active material | | Binder | | | auxiliary agent | | Dispersant | |
| | Electrode | | | Mass | | Mass | Dissolution/ | | Mass | | Mass |
| Ex. | type | Base | Material | ratio | Material | ratio | dispersion | Material | ratio | Material | ratio |
| Ex. 23 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 24 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 25 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 26 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 27 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |
| Ex. 28 | Liquid LIB | Aluminum foil | NCM | 100 | P(DEAmEMA [symbol] | 1.5 | Soluble | AB | 3 | BYK-ET3000 | 0.2 |
| | positive | | | | BMA | | | | | | |
| | electrode | | | | | | | | | | |
| Ex. 29 | Solid LIB | Aluminum foil | LiNbO3/ | 100 | PBMA | 3 | Soluble | AB | 3 | S13940 | 1.8 |
| | positive | | NCM | | | | | | | | |
| | electrode | | | | | | | | | | |
| Ex. 30 | Solid LIB | Aluminum foil | LiNbO3/ | 100 | PBMA | 3 | Soluble | AB | 3 | S13940 | 1.8 |
| | positive | | NCM | | | | | | | | |
| | electrode | | | | | | | | | | |
| Ex. 31 | Solid LIB | Aluminum foil | LiNbO3/ | 100 | PBMA | 3 | Soluble | AB | 3 | S13940 | 1.8 |
| | positive | | NCM | | | | | | | | |
| | electrode | | | | | | | | | | |
| Ex. 32 | Solid LIB | Aluminum foil | LiNbO3/ | 100 | P(DEAmEMA [symbol] | 3 | Soluble | AB | 3 | S13940 | 1.8 |
| | positive | | NCM | | BMA) | | | | | | |
| | electrode | | | | | | | | | | |
| Ex. 33 | Solid LIB | Aluminum foil | LiNbO3/ | 100 | P(DEAmEMA [symbol] | 3 | Soluble | AB | 3 | S13940 | 1.8 |
| | positive | | NCM | | BMA) | | | | | | |
| | electrode | | | | | | | | | | |
| Ex. 34 | Solid LIB | Aluminum foil | LiNbO3/ | 100 | P(DEAmEMA [symbol] | 3 | Soluble | AB | 3 | S13940 | 1.8 |
| | positive | | NCM | | BMA) | | | | | | |
| | electrode | | | | | | | | | | |

| | Electrode composite layer-forming liquid composition | | | | | | | | |
|---|---|---|---|---|---|---|---|---|---|
| | Other components | | | | | | | | |
| | Solid Electrolyte | | Dispersion medium | | Solid | Viscosity at | | | |
| | | Mass | | Mass | content | 100 rpm | Thixotropy | Applying | Pressing |
| Ex. | Material | ratio | Material | ratio | [wt %] | [cp] | index | method | process |
| Ex. 23 | — | — | NMP | 69.8 | 60 | 20 | 1.5 | Inkjet printing | Yes |
| Ex. 24 | — | — | NMP | 69.8 | 60 | 20 | 1.5 | Inkjet printing | Yes |
| Ex. 25 | — | — | NMP | 56.4 | 65 | 40 | 2.5 | Inkjet printing | Yes |
| Ex. 26 | — | — | NMP | 44.9 | 70 | 60 | 3 | Inkjet printing | Yes |
| Ex. 27 | — | — | NMP | 69.8 | 60 | 20 | 1.5 | Inkjet printing | Yes |
| Ex. 28 | — | — | NMP | 69.8 | 60 | 20 | 1.5 | Inkjet printing | Yes |
| Ex. 29 | LPSC | 32 | Butyl | 93.2 | 60 | 20 | 1.5 | Inkjet printing | Yes |
| | | | butyrate | | | | | | |
| Ex. 30 | LPSC | 32 | Butyl | 75.3 | 65 | 50 | 2.1 | Inkjet printing | Yes |
| | | | butyrate | | | | | | |
| Ex. 31 | LPSC | 32 | Butyl | 59.9 | 70 | 80 | 2.6 | Inkjet printing | Yes |
| | | | butyrate | | | | | | |
| Ex. 32 | LPSC | 32 | Butyl | 93.2 | 60 | 20 | 1.5 | Inkjet printing | Yes |
| | | | butyrate | | | | | | |
| Ex. 33 | LPSC | 32 | Butyl | 75.3 | 65 | 50 | 2.1 | Inkjet printing | Yes |
| | | | butyrate | | | | | | |
| Ex. 34 | LPSC | 32 | Butyl | 59.9 | 70 | 80 | 2.6 | Inkjet printing | Yes |
| | | | butyrate | | | | | | |

[symbol]

indicates data missing or illegible when filed

TABLE 4

| | | | Electrode composite layer-forming liquid composition | | | | | | | | |
|---|---|---|---|---|---|---|---|---|---|---|---|
| | | | | | | | | Other components | | | |
| | | | | | | | | Conductive | | | |
| | | | Active material | | Binder | | | auxiliary agent | | Dispersant | |
| | Electrode | | | Mass | | Mass | Dissolution/ | | Mass | | Mass |
| C.E. | type | Base | Material | ratio | Material | ratio | dispersion | Material | ratio | Material | ratio |
| C.E. 1 | Liquid LIB | Copper foil | Gr:SiO | 80:20:00 | SBR | 5 | Particulate | AB | 1 | CMC | 1 |
| | negative | | | | | | | | | | |
| | electrode | | | | | | | | | | |
| C.E. 2-1 | Liquid LIB | Copper foil | Gr:SiO | 80:20:00 | SBR | 2.5 | Particulate | AB | 1 | CMC | 1 |
| C.E. 2-2 | negative | | Gr:SiO | 80:20:00 | SBR | 7.5 | Particulate | AB | 1 | CMC | 1 |
| | electrode | | | | | | | | | | |
| C.E. 3 | Liquid LIB | Copper foil | SiO | 100 | Urethane- | 5 | Soluble | SWCNT | 0.1 | CMC | 1 |
| | negative | | | | based | | | | | | |
| | electrode | | | | binder | | | | | | |
| C.E. 4 | Liquid LIB | Copper foil | SiO | 100 | Urethane- | 5 | Soluble | SWCNT | 0.1 | CMC | 1 |
| | negative | | | | based | | | | | | |
| | electrode | | | | binder | | | | | | |
| C.E. 5 | Liquid LIB | Aluminum foil | NCM | 100 | P(DEAmEMA [symbol] | 1.5 | Soluble | AB | 3 | BYK-ET3000 | 0.2 |
| | positive | | | | BMA | | | | | | |
| | electrode | | | | | | | | | | |
| C.E. 6-1 | Liquid LIB | Aluminum foil | NCM | 100 | P(DEAmEMA [symbol] | 0.75 | Soluble | AB | 3 | BYK-ET3000 | 0.2 |
| | positive | | | | BMA) | | | | | | |
| C.E. 6-2 | electrode | | NCM | 100 | P(DEAmEMA [symbol] | 2.25 | Soluble | AB | 3 | BYK-ET3000 | 0.2 |
| | | | | | BMA) | | | | | | |
| C.E. 7 | Liquid LIB | Aluminum foil | NCM | 100 | P(DEAmEMA [symbol] | 1.5 | Soluble | AB | 3 | BYK-ET3000 | 0.2 |
| | positive | | | | BMA) | | | | | | |
| | electrode | | | | | | | | | | |

| | Electrode composite layer-forming liquid composition | | | | | | | | |
|---|---|---|---|---|---|---|---|---|---|
| | Other components | | | | | | | | |
| | Solid Electrolyte | | Dispersion medium | | Solid | Viscosity at | | | |
| | | Mass | | Mass | content | 100 rpm | Thixotropy | Applying | Pressing |
| C.E. | Material | ratio | Material | ratio | [wt %] | [cp] | index | method | process |
| C.E. 1 | — | — | Water | 198.7 | 35 | 20 | 1.2 | Die coating | No |
| C.E. 2-1 | — | — | Water | 194.1 | 35 | 20 | 1.2 | Overcoating | No |
| C.E. 2-2 | — | — | Water | 203.4 | 35 | 20 | 1.2 | | |
| C.E. 3 | — | — | Water | 157.6 | 40 | 70 | 3 | Die coating | No |
| C.E. 4 | — | — | Water | 157.6 | 40 | 70 | 3 | Die coating | No |
| C.E. 5 | — | — | NMP | 69.8 | 60 | 20 | 1.5 | Die coating | Yes |
| C.E. 6-1 | — | — | NMP | 69.3 | 60 | 20 | 1.5 | Overcoating | Yes |
| C.E. 6-2 | — | — | NMP | 70.3 | 60 | 20 | 1.5 | | |
| C.E. 7 | — | — | NMP | 104.5 | 50 | 10 | 1.1 | IJ overcoating | Yes |

[symbol]

indicates data missing or illegible when filed

TABLE 5

| | Evaluation items | | | | | | | |
|---|---|---|---|---|---|---|---|---|
| | Evaluation | Period | | t_{High} < | φ_{High} > | C_{High, Surface} > | Rate | Cycle |
| Ex. | method | T | Continuity | t_{Low} | φ_{Low} | C_{High, Under} | characteristics | characteristics |
| Ex. 1 | Method B | 2.50 | Yes | No | No | No | C-minus | C-minus |
| Ex. 2 | Method B | 1.69 | Yes | No | No | No | C | C |
| Ex. 3 | Method B | 1.27 | Yes | No | No | No | B | B |
| Ex. 4 | Method B | 0.85 | Yes | No | No | No | B | B |
| Ex. 5 | Method B | 0.64 | Yes | No | No | No | B | B |
| Ex. 6 | Method B | 0.42 | Yes | No | No | No | C | C |
| Ex. 7 | Method B | 0.21 | Yes | No | No | No | C-minus | C-minus |
| Ex. 8 | Method B | 1.27 | Yes | Yes | No | No | A | A |
| Ex. 9 | Method B | 1.27 | Yes | No | Yes | No | A | A |
| Ex. 10 | Method B | 1.27 | Yes | Yes | Yes | No | A | A |
| Ex. 11 | Methods A, B | 1.27 | Yes | No | No | Yes | B | B |

TABLE 6

| | Evaluation items | | | | | | | |
|---|---|---|---|---|---|---|---|---|
| | Evaluation | Period | | t_{High} < | φ_{High} > | C_{High, Surface} > | Rate | Cycle |
| Ex. | method | T | Continuity | t_{Low} | φ_{Low} | C_{High, Under} | characteristics | characteristics |
| Ex. 12 | Methods A, B | 1.27 | Yes | Yes | No | Yes | A | A |
| Ex. 13 | Methods A, B | 1.27 | Yes | No | Yes | Yes | A | A |
| Ex. 14 | Methods A, B | 1.27 | Yes | Yes | Yes | Yes | A | A |
| Ex. 15 | Method B | 2.82 | Yes | No | No | No | C-minus | C-minus |
| Ex. 16 | Method B | 0.17 | Yes | No | No | No | C-minus | C-minus |
| Ex. 17 | Methods A, B | 1.27 | Yes | Yes | Yes | Yes | B | B |
| Ex. 18 | Methods A, B | 2.50 | Yes | No | No | Yes | C-minus | C-minus |
| Ex. 19 | Methods A, B | 1.69 | Yes | No | No | Yes | C | C |
| Ex. 20 | Methods A, B | 1.27 | Yes | No | No | Yes | B | B |
| Ex. 21 | Methods A, B | 0.85 | Yes | No | No | Yes | B | B |
| Ex. 22 | Methods A, B | 0.64 | Yes | No | No | Yes | B | B |

TABLE 7

| | Evaluation items | | | | | | | |
|---|---|---|---|---|---|---|---|---|
| | Evaluation | Period | | t_{High} < | φ_{High} > | C_{High, Surface} > | Rate | Cycle |
| Ex. | method | T | Continuity | t_{Low} | φ_{Low} | C_{High, Under} | characteristics | characteristics |
| Ex. 23 | Methods A, B | 0.42 | Yes | No | No | Yes | C | C |
| Ex. 24 | Methods A, B | 0.2 | Yes | No | No | Yes | C-minus | C-minus |
| Ex. 25 | Methods A, B | 1.27 | Yes | No | Yes | Yes | A | A |
| Ex. 26 | Methods A, B | 1.27 | Yes | Yes | Yes | Yes | A | A |
| Ex. 27 | Methods A, B | 2.82 | Yes | No | No | Yes | C-minus | C-minus |
| Ex. 28 | Methods A, B | 0.17 | Yes | No | No | Yes | C-minus | C-minus |
| Ex. 29 | Methods A, B | 1.27 | Yes | No | No | Yes | B | B |
| Ex. 30 | Methods A, B | 1.27 | Yes | No | Yes | Yes | A | A |
| Ex. 31 | Methods A, B | 1.27 | Yes | Yes | Yes | Yes | A | A |
| Ex. 32 | Methods A, B | 1.27 | Yes | No | No | Yes | B | B |
| Ex. 33 | Methods A, B | 1.27 | Yes | No | Yes | Yes | A | A |
| Ex. 34 | Methods A, B | 1.27 | Yes | Yes | Yes | Yes | A | A |

TABLE 8

| | Evaluation items | | | | | | | |
|---|---|---|---|---|---|---|---|---|
| | Evaluation | Period | | t_{High} < | φ_{High} > | C_{High, Surface} > | Rate | Cycle |
| C.E. | method | T | Continuity | t_{Low} | φ_{Low} | C_{High, Under} | characteristics | characteristics |
| C.E. 1 | Method B | — | Yes | No | No | No | D | D |
| C.E. 2-1 | Method B | 2.54 | No | No | No | No | D | C-minus |
| C.E. 2-2 | | | | | | | | |
| C.E. 3 | Methods A, B | — | Yes | No | No | No | D | D |
| C.E. 4 | Methods A, B | — | Yes | No | No | No | D | D |
| C.E. 5 | Methods A, B | — | Yes | No | No | No | D | D |
| C.E. 6-1 | Methods A, B | 2.54 | No | No | No | No | D | D |
| C.E. 6-2 | | | | | | | | |
| C.E. 7 | Methods A, B | — | Yes | No | No | No | C | D |

The results of Examples 1 to 34 indicate that excellent cycle characteristics can be obtained when the period Tis 0.2 mm or more and 2.5 mm or less. In particular, when the thickness is in the range of 0.4 mm or more and 1.7 mm or less, an electrode having better cycle characteristics can be obtained, and when the thickness is in the range of 0.6 mm or more and 1.3 mm or less, an electrode having extremely better cycle characteristics can be obtained.

The results of Example 8 indicate that, when the solid content concentration or viscosity of the negative electrode composite layer-forming liquid composition is increased, the time required for merged droplets to spread becomes longer, and thus an electrode that satisfies t_{High}<t_{Low} is obtained. As a result, an electrode having excellent cycle characteristics can be obtained.

The result of Example 9 indicates that the pressing step can be used to produce an electrode that satisfies φ_{High}>φ_{Low}. As a result, an electrode having excellent cycle characteristics and volumetric energy density can be obtained.

The results of Example 10 and Example 26 indicate that further increased solid content concentration results in a larger difference between t_{High} and t_{Low}, and production of an electrode that satisfies t_{High}<t_{Low} and φ_{High}>φ_{Low} even after being subjected to the pressing step. As a result, an electrode having excellent cycle characteristics and volumetric energy density can be obtained.

The results of Examples 11 to 14 indicate that the use of a soluble binder results in production of a negative electrode that satisfies A_{High, surface}>A_{High, Under}. As a result, an electrode having more excellent cycle characteristics can be obtained.

The results of Comparative Example 1 and Comparative Example 5 indicate that the electrodes without periodic binder concentration variation in the electrode composite layer did not exhibit excellent cycle characteristics.

The results of Comparative Example 2 and Comparative Example 6 indicate that the electrodes with discontinuous binder concentration in the electrode composite layer did not exhibit excellent cycle characteristics.

The results of Comparative Example 7 indicates that, even if the inkjet method was used, the producing method in which coating and drying were performed multiple times did not provide a periodic binder concentration distribution and exhibited no improvement in cycle characteristics.

The results of Example 17 and Comparative Example 3 indicate that even when only SiO is used as the negative electrode active material, excellent cycle characteristics can be obtained for the electrode with periodical variation of binder concentration in the electrode composite layer. For the negative electrode produced in Comparative Example 4, due to the low drying temperature and the long drying time, it was visually observed that the binder was uniformly concentrated in the surface layer of the negative electrode. In other words, a negative electrode in which the binder concentration distribution exists only in the thickness direction (the binder concentration is uniformly high on the surface layer side) was produced. That negative electrode did not exhibit excellent rate characteristics (because the binder covered the entire surface, and hindered the movement of the electrolyte).

Aspects of the present disclosure include the following, for example.

According to a first aspect,
an electrode includes a base, and
an electrode composite layer on the base, including an active material and a binder,
in which a concentration of the binder in the electrode composite layer varies periodically and continuously in at least one direction perpendicular to a thickness direction of the electrode composite layer.

According to a second aspect,
in the electrode of the first aspect, a period of the concentration of the binder is 0.2 mm or more and 2.5 mm or less.

According to a third aspect,
in the electrode of the first aspect or the second aspect, the electrode composite layer includes a region A_{High} having a binder concentration higher than an average binder concentration in the electrode composite layer, and a region A_{Low} having a binder concentration lower than the average binder concentration in the electrode composite layer, and
an average thickness t_{High} of the region A_{High} and an average thickness t_{Low} of the region A_{Low} satisfy the following Expression (1):

$${t}_{High} < {t}_{Low} . \qquad Expression ( 1 )$$

According to a fourth aspect,
in the electrode of any one of the first aspect to the third aspect, the electrode composite layer includes a region A_{High} having a binder concentration higher than an average binder concentration in the electrode composite layer, and a region A_{Low} having a binder concentration lower than the average binder concentration in the electrode composite layer, and
an average porosity φ_{High} of the region A_{High} and an average porosity φ_{Low} of the region A_{Low} satisfy the following Expression (2):

$${φ}_{High} > {φ}_{Low} . \qquad Expression ( 2 )$$

According to a fifth aspect,
in the electrode of any one of the first aspect to the fourth aspect, the electrode composite layer includes a region A_{High} having a binder concentration higher than an average binder concentration in the electrode composite layer,
in which, when the electrode composite layer is divided, by an imaginary line equally dividing, in two, the average thickness t_{High} of the region A_{High} and extending in a direction perpendicular to the thickness direction of the electrode composite layer, to a region A_{High, Under} on the base side and a region A_{High, surface} not on the base side, and
an average binder concentration C_{High, Under} of the region A_{High, Under} and an average binder concentration C_{High, surface} of the region A_{High, surface} satisfy the following Expression (3):

$${C}_{High , Under} < {C}_{High , surface} . \qquad Expression ( 3 )$$

According to a sixth aspect,
a method for producing an electrode includes forming an electrode composite layer on a base, and the forming includes,
applying, onto the base, an electrode composite layer-forming liquid composition including an active material, a binder, and a dispersion medium, and
drying the applied electrode composite layer-forming liquid composition,
in which a concentration of the binder in the electrode composite layer varies periodically and continuously in at least one direction perpendicular to a thickness direction of the electrode composite layer.

According to a seventh aspect,
in the method for producing an electrode of the sixth aspect, the applying includes applying the electrode composite layer-forming liquid composition onto the base at a period of 0.2 mm or more and 2.5 mm or less.

According to an eighth aspect,
in the method for producing an electrode of the sixth aspect or the seventh aspect, the drying includes drying the electrode composite layer-forming liquid composition before the electrode composite layer-forming liquid composition becomes flat.

According to a ninth aspect,
the method for producing an electrode of any one of the sixth aspect to the eighth aspect further includes waiting between the applying and the drying.

According to a tenth aspect,
in the method for producing an electrode of any one of the sixth aspect to the ninth aspect, in the electrode composite layer-forming liquid composition, the binder is dissolved in the dispersion medium.

According to an eleventh aspect,
the method for producing an electrode of any one of the sixth aspect to the tenth aspect further includes performing pressing.

According to the electrode according to any one of the first to fifth aspects, and the method for producing an electrode according to any one of the sixth to eleventh aspects, it is possible to solve the problems in the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An electrode comprising:
a base; and
an electrode composite layer on the base, the electrode composite layer including an active material and a binder,
wherein a concentration of the binder in the electrode composite layer varies periodically and continuously in at least one direction perpendicular to a thickness direction of the electrode composite layer.

2. The electrode according to claim 1, wherein a period of the concentration of the binder is 0.2 mm or more and 2.5 mm or less.

3. The electrode according to claim 1, wherein the electrode composite layer includes a region A_{High} having a binder concentration higher than an average binder concentration in the electrode composite layer, and a region A_{Low} having a binder concentration lower than the average binder concentration in the electrode composite layer, and
an average thickness t_{High} of the region A_{High} and an average thickness t_{Low} of the region A_{Low} satisfy the following Expression (1):
$${t}_{High} < {t}_{Low} . \qquad Expression ( 1 )$$

4. The electrode according to claim 1, wherein the electrode composite layer includes a region A_{High} having a binder concentration higher than an average binder concentration in the electrode composite layer, and a region A_{Low} having a binder concentration lower than the average binder concentration in the electrode composite layer, and
an average porosity φ_{High} of the region A_{High} and an average porosity φ_{Low} of the region A_{Low} satisfy the following Expression (2):
$${φ}_{High} > {φ}_{Low} . \qquad Expression ( 2 )$$

5. The electrode according to claim 1, wherein the electrode composite layer includes a region A_{High} having a binder concentration higher than an average binder concentration in the electrode composite layer,
wherein, when the electrode composite layer is divided, by an imaginary line equally dividing, in two, an average thickness t_{High} of the region A_{High} and extending in a direction perpendicular to the thickness direction of the electrode composite layer, to a region A_{High, Under} on a side of the base and a region A_{High, surface} not on the side of the base,
an average binder concentration C_{High, Under} of the region A_{High, Under} and an average binder concentration C_{High}, surface of the region A_{High, surface} satisfy the following Expression (3):
$${C}_{High , Under} < {C}_{High , surface} . \qquad Expression ( 3 )$$

6. A method for producing an electrode, the method comprising:
forming an electrode composite layer on a base, the forming includes:
applying, onto the base, an electrode composite layer-forming liquid composition including an active material, a binder, and a dispersion medium; and
drying the applied electrode composite layer-forming liquid composition,
wherein a concentration of the binder in the electrode composite layer varies periodically and continuously in at least one direction perpendicular to a thickness direction of the electrode composite layer.

7. The method according to claim 6, wherein the applying includes applying the electrode composite layer-forming liquid composition onto the base at a period of 0.2 mm or more and 2.5 mm or less.

8. The method according to claim 6, wherein the drying includes drying the electrode composite layer-forming liquid composition before the electrode composite layer-forming liquid composition becomes flat.

9. The method according to claim 6, further comprising waiting between the applying and the drying.

10. The method according to claim 6, wherein, in the electrode composite layer-forming liquid composition, the binder is dissolved in the dispersion medium.

11. The method according to claim 6, further comprising performing pressing.
